(19) United States
(12) Patent Application Publication
(10) Pub. No.: US 2026/0037233 A1
(43) Pub. Date: Feb. 5, 2026

(54) COMMUNICATIONS SESSION HANDLING

(71) Applicant: MAP Communications, Inc., Chesapeake, VA (US)

(72) Inventors: Vaibhav Dani, Chesapeake, VA (US); Krystal White, Chesapeake, VA (US); Nate Stallings, Chesapeake, VA (US); Jason Austin, Chesapeake, VA (US); Kumar Swamy, Chesapeake, VA (US); Taylor Beitler, Chesapeake, VA (US)

(21) Appl. No.: 19/277,234

(22) Filed: Jul. 22, 2025

Related U.S. Application Data
(60) Provisional application No. 63/677,993, filed on Jul. 31, 2024.

(51) Int. Cl. G06F 8/34; G06F 3/0482; G06F 3/0484; H04L 67/00

(52) U.S. Cl. CPC G06F 8/34; G06F 3/0482; G06F 3/0484; H04L 67/34

(57) ABSTRACT

Various aspects of the subject technology relate to methods, systems, and machine-readable media for generating executable programming code for a communications session flow. Various aspects may include providing, by a communications session handling system, a visual programming environment for developing a communications session flow. Aspects may also include adding, via a canvas of the visual programming environment, graphical programming objects to the communications session flow. Aspects may also include associating the graphical programming objects by links representing a directional dependency between pairs of graphical programming objects. Aspects may also include configuring a parameter of a graphical programming object. Aspects may also include determining, based on at least the graphical programming objects and the links, a validity of a functionality of the communications session flow. Aspects may also include generating, based on the validity of the communications session flow, an executable programming code implementing the functionality of the communications session flow.

### CROSS-REFERENCE TO RELATED APPLICATIONS

The present application claims the benefit of priority under 35 U.S.C. § 119 from U.S. Provisional Patent Application Ser. No. 63/677,993 entitled “COMMUNICATIONS SESSION HANDLING,” to Vaibhav Dani et al., filed on Jul. 31, 2024, the disclosure of which is hereby incorporated by reference in its entirety for all purposes.

### BACKGROUND

### Field

The present disclosure generally relates to answering services. More particularly, the present disclosure relates to managing virtual receptionist services via an integrated software platform.

### Related Art

The evolution of customer service technologies has highlighted the need for efficient and comprehensive receptionist services, especially in the context of small to medium-sized enterprises (SMEs) and professional services. These and many other entities require robust systems to handle a variety of tasks, such as communications session routing, customer interactions, sales processes, billing, and reporting, all while ensuring scalability and adaptability for evolving business needs.

### SUMMARY

The subject disclosure provides for an integrated software platform for managing virtual receptionist services.

According to certain embodiments of the present disclosure, a computer-implemented method for generating executable programming code for a communications session flow is provided. The computer-implemented method may include providing, by a communications session handling system, a visual programming environment for developing a communications session flow. The computer-implemented method may include adding, via a canvas of the visual programming environment, two or more graphical programming objects to the communications session flow. The two or more graphical programming objects may represent predefined programming elements. The computer-implemented method may include associating at least two of the two or more graphical programming objects by one or more links representing a directional dependency between respective pairs of the two or more graphical programming objects. The computer-implemented method may include configuring a parameter of at least one of the two or more graphical programming objects. The computer-implemented method may include determining, based on at least the two or more graphical programming objects and the one or more links, a validity of a functionality of the communications session flow. The computer-implemented method may include generating, based on the validity of the communications session flow, an executable programming code implementing the functionality of the communications session flow.

According to another embodiment of the present disclosure, a system is provided. The system may include one or more processors. The system may include one or more memories coupled to at least one of the one or more processors, wherein the one or more memories comprise computer-readable program instructions, which when executed by at least one of the one or more processors, cause the system to perform operations. The operations may include providing, by a communications session handling system, a visual programming environment for developing a communications session flow. The operations may include adding, via a canvas of the visual programming environment, two or more graphical programming objects to the communications session flow. The two or more graphical programming objects may represent predefined programming elements. The operations may include associating at least two of the two or more graphical programming objects by one or more links representing a directional dependency between respective pairs of the two or more graphical programming objects. The operations may include configuring a parameter of at least one of the two or more graphical programming objects. The operations may include determining, based on at least the two or more graphical programming objects and the one or more links, a validity of a functionality of the communications session flow. The operations may include generating, based on the validity of the communications session flow, an executable programming code implementing the functionality of the communications session flow.

According to yet other embodiments of the present disclosure, a non-transitory computer-readable storage medium including computer-readable instructions embodied therein, which when executed by one or more processors, cause a computer system to perform operations, is provided. The operations may include providing, by a communications session handling system, a visual programming environment for developing a communications session flow. The operations may include adding, via a canvas of the visual programming environment, two or more graphical programming objects to the communications session flow. The two or more graphical programming objects may represent predefined programming elements. The operations may include associating at least two of the two or more graphical programming objects by one or more links representing a directional dependency between respective pairs of the two or more graphical programming objects. The operations may include configuring a parameter of at least one of the two or more graphical programming objects. The operations may include determining, based on at least the two or more graphical programming objects and the one or more links, a validity of a functionality of the communications session flow. The operations may include generating, based on the validity of the communications session flow, an executable programming code implementing the functionality of the communications session flow.

According to certain embodiments of the present disclosure, a computer-implemented method for assisting human agents of a communications session handling system during a communications session is provided. The computer-implemented method may include generating, by a communications session handling system, a real-time transcript of a communications session between a third party and an automated agent of the communications session handling system. The computer-implemented method may include transferring the communications session from the automated agent to a queue of a human agent of the communications session handling system. The computer-implemented method may include providing, via a user interface, the real-time transcript to the human agent. The computer-implemented method may include establishing, based on an input of the human agent, a connection between the third party and the human agent. The computer-implemented method may include generating, based on information associated with a profile of a customer of the communications session handling system, a suggested prompt for the human agent to provide to the third party. The computer-implemented method may include updating, via the user interface, the real-time transcript with the suggested prompt.

According to another embodiment of the present disclosure, a system is provided. The system may include one or more processors. The system may include one or more memories coupled to at least one of the one or more processors, wherein the one or more memories comprise computer-readable program instructions, which when executed by at least one of the one or more processors, cause the system to perform operations. The operations may include generating, by a communications session handling system, a real-time transcript of a communications session between a third party and an automated agent of the communications session handling system. The operations may include transferring the communications session from the automated agent to a queue of a human agent of the communications session handling system. The operations may include providing, via a user interface, the real-time transcript to the human agent. The operations may include establishing, based on an input of the human agent, a connection between the third party and the human agent. The operations may include generating, based on information associated with a profile of a customer of the communications session handling system, a suggested prompt for the human agent to provide to the third party. The operations may include updating, via the user interface, the real-time transcript with the suggested prompt.

According to yet other embodiments of the present disclosure, a non-transitory computer-readable storage medium including computer-readable instructions embodied therein, which when executed by one or more processors, cause a computer system to perform operations, is provided. The operations may include generating, by a communications session handling system, a real-time transcript of a communications session between a third party and an automated agent of the communications session handling system. The operations may include transferring the communications session from the automated agent to a queue of a human agent of the communications session handling system. The operations may include providing, via a user interface, the real-time transcript to the human agent. The operations may include establishing, based on an input of the human agent, a connection between the third party and the human agent. The operations may include generating, based on information associated with a profile of a customer of the communications session handling system, a suggested prompt for the human agent to provide to the third party. The operations may include updating, via the user interface, the real-time transcript with the suggested prompt.

According to certain embodiments of the present disclosure, a computer-implemented method for masking an originating identifier of an agent of a communications session handling system is provided. The computer-implemented method may include associating, by a communications session handling system, a plurality of identifiers with an account of a customer. The computer-implemented method may include receiving, from the customer, a request for an agent of a plurality of agents of the communications session handling system to conduct a communications session with a third party, on behalf of the customer. The request may include a selection, from one or more identifiers of the plurality of identifiers associated with the account of the customer, of an originating identifier for the communications session. The computer-implemented method may include adding the request to a queue of a first agent of the plurality of agents of the communications session handling system. The computer-implemented method may include receiving, from the first agent, an acceptance of the request. The computer-implemented method may include populating, via a user interface of the first agent, an originating identifier field of a communications session form with the selected originating identifier. The computer-implemented method may include initiating, based on the communications session form, the communications session using the selected originating identifier associated with the account of the customer.

According to another embodiment of the present disclosure, a system is provided. The system may include one or more processors. The system may include one or more memories coupled to at least one of the one or more processors, wherein the one or more memories comprise computer-readable program instructions, which when executed by at least one of the one or more processors, cause the system to perform operations. The operations may include associating, by a communications session handling system, a plurality of identifiers with an account of a customer. The operations may include receiving, from the customer, a request for an agent of a plurality of agents of the communications session handling system to conduct a communications session with a third party, on behalf of the customer. The request may include a selection, from one or more identifiers of the plurality of identifiers associated with the account of the customer, of an originating identifier for the communications session. The operations may include adding the request to a queue of a first agent of the plurality of agents of the communications session handling system. The operations may include receiving, from the first agent, an acceptance of the request. The operations may include populating, via a user interface of the first agent, an originating identifier field of a communications session form with the selected originating identifier. The operations may include initiating, based on the communications session form, the communications session using the selected originating identifier associated with the account of the customer.

According to yet other embodiments of the present disclosure, a non-transitory computer-readable storage medium including computer-readable instructions embodied therein, which when executed by one or more processors, cause a computer system to perform operations, is provided. The operations may include associating, by a communications session handling system, a plurality of identifiers with an account of a customer. The operations may include receiving, from the customer, a request for an agent of a plurality of agents of the communications session handling system to conduct a communications session with a third party, on behalf of the customer. The request may include a selection, from one or more identifiers of the plurality of identifiers associated with the account of the customer, of an originating identifier for the communications session. The operations may include adding the request to a queue of a first agent of the plurality of agents of the communications session handling system. The operations may include receiving, from the first agent, an acceptance of the request. The operations may include populating, via a user interface of the first agent, an originating identifier field of a communications session form with the selected originating identifier. The operations may include initiating, based on the communications session form, the communications session using the selected originating identifier associated with the account of the customer.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a network architecture suitable for providing an integrated software platform for managing virtual receptionist services, according to certain aspects of the present disclosure;

FIG. 2 is a block diagram illustrating details of a client device and a server used in a network architecture as disclosed herein, according to certain aspects of the present disclosure;

FIG. 3 is a block diagram illustrating an example system with which aspects of the subject technology may be implemented;

FIG. 4 illustrates a flowchart representing a process for communications session handling by a virtual receptionist system, according to certain aspects of the present disclosure;

FIG. 5 illustrates a display of an example graphical user interface for defining roles of agents of a virtual receptionist system, according to certain aspects of the present disclosure;

FIG. 6 illustrates a display of an example graphical user interface for defining skills of agents of a virtual receptionist system, according to certain aspects of the present disclosure;

FIG. 7 illustrates a display of an example graphical user interface for defining skill groups of agents of a virtual receptionist system, according to certain aspects of the present disclosure;

FIG. 8 illustrates a display of an example graphical user interface for defining teams of agents of a virtual receptionist system, according to certain aspects of the present disclosure;

FIGS. 9A and 9B illustrate displays of an example graphical user interface for defining queues of agents of a virtual receptionist system, according to certain aspects of the present disclosure;

FIGS. 10A and 10B illustrate displays of an example graphical user interface for creating or configuring an account of a customer of a virtual receptionist system, according to certain aspects of the present disclosure;

FIGS. 11A-11C illustrate displays of an example graphical user interface for generating interaction forms for a virtual receptionist system, according to certain aspects of the present disclosure;

FIGS. 12A-12F illustrate displays of an example graphical user interface for developing communications session flows for a virtual receptionist system, according to certain aspects of the present disclosure;

FIG. 13 illustrates an example artificial intelligence (AI) insights panel of a dashboard of a graphical user interface of a virtual receptionist system, according to certain aspects of the present disclosure;

FIGS. 14A and 14B illustrate displays of forms for enabling a customer to request that an agent of a virtual receptionist system conduct a communications session with a third party, on behalf of the customer, according to certain aspects of the present disclosure;

FIGS. 15A and 15B illustrate displays of forms for enabling a customer to initiate an outbound communication using an identifier associated with an account of the customer, according to certain aspects of the present disclosure;

FIGS. 16A and 16B illustrate displays of an example graphical user interface for generating communications session quality reports associated with a virtual receptionist platform, according to certain aspects of the present disclosure;

FIGS. 17A and 17B illustrate displays of an example graphical user interface for generating quotes for a customer of a virtual receptionist system, according to certain aspects of the present disclosure;

FIG. 18 illustrates an exemplary workflow for a process for generating executable programming code for a communications session flow, according to certain aspects of the present disclosure;

FIG. 19 illustrates an exemplary workflow for a process for assisting human agents of a communications session handling system during a communications session, according to certain aspects of the present disclosure;

FIG. 20 illustrates an exemplary workflow for masking an originating identifier of an agent of a communications session handling system, according to certain aspects of the present disclosure; and

FIG. 21 is a block diagram illustrating an exemplary computer system with which aspects of the subject technology may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, any drawings and descriptions are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The evolution of customer service technologies has highlighted the need for efficient and comprehensive receptionist services, especially in the context of small to medium-sized enterprises (SMEs) and professional services. These and many other entities require robust systems to handle a variety of tasks, such as communications session routing, customer interactions, sales processes, billing, and reporting, all while ensuring scalability and adaptability for evolving business needs.

Like traditional receptionist services, such as in-person or on-site receptionist services, virtual receptionist services may include a wide range of tasks and functionalities designed to assist a customer (for example, a business entity) in managing communications and administrative tasks more efficiently. Receptionist services may include communications session management (for example, answering, routing, screening, forwarding, message taking, voicemail management, recording), appointment scheduling (for example, calendar management, reminders), support service (for example, customer intake, inquiry handling, problem resolution), and sales (for example, lead qualification, promotions management, order processing), billing (for example, invoicing, payment processing), and administrative support (for example, email management, data entry), along with operational reporting. Unlike traditional receptionist services, virtual receptionist services may be offered from a remote location (for example, a third-party call center).

Traditionally, business entities have relied on fragmented solutions to manage various virtual receptionist services. Such fragmented solutions may require the collection and reconciliation of data and reporting from multiple systems (for example, a sales system, a billing and payment system, and a data analytics and real-time monitoring system) and may require continuous manual intervention to ensure accuracy and visibility, resulting in inefficiencies, increased costs, limited scalability, and inconsistent customer experiences.

As disclosed herein, novel systems and methods represent a significant advancement in the field of answering service technology by providing for managing virtual receptionist services via an integrated software platform. The systems and methods may leverage artificial intelligence (AI) techniques (for example, natural language processing (NLP) techniques, machine learning (ML) techniques) to understand user inputs, generate user prompts, ensure data accuracy, provide real-time analytics and troubleshooting, improve efficiency, and increase user satisfaction.

Herein, a customer of a virtual receptionist platform may refer to an individual or an organization (for example, a for-profit business entity, a non-profit business entity) that utilizes services of the virtual receptionist platform to handle communications sessions (for example, telephone calls, text-based messaging conversations) with clients of the customer. Herein, a client may refer to an individual or an organization that solicits products (for example, goods, services) of a customer. Herein, an agent may refer to a representative of a virtual receptionist platform. By way of non-limiting examples, an agent may include an administrator, a supervisor, a receptionist, a sales representative, or the like. In some embodiments, an agent may receive communications sessions from or may initiate communications sessions with a client or a customer. By way of non-limiting example, a client may initiate a telephone call to a customer, and the telephone call may be answered by an agent.

According to some embodiments, a virtual receptionist platform may handle a communications session (for example, a telephone call, a text-based messaging conversation) initiated by or involving a client of a customer of the virtual receptionist platform. By way of non-limiting example, the customer may include a business entity, such as a general contractor, a healthcare provider, or a financial firm. An initiated or an ongoing communications session may be routed to an agent (for example, human agent or automated agent) associated with the virtual receptionist platform based on an attribute of the agent. By way of non-limiting examples, an agent attribute may include a skill (for example, software proficiency, language fluency), a role (for example, administrator, supervisor, translator), an access privilege (for example, service configuration access, billing accounts access), a geographic location, or an availability of the agent.

In some embodiments disclosed herein, a technical solution is provided for the technical problem of simplifying the creation, testing, and deployment of communications session flow logic without requiring traditional coding. According to some aspects of the embodiments, a virtual receptionist platform may generate executable programming code for a communications session flow. The virtual receptionist platform may provide a visual programming environment for developing the communications session flow. Graphical programming objects—such as blocks, nodes, or widgets—may be added to the communications session flow. Graphical programming objects may represent predefined programming elements—such as data types, control structures, functions, methods, operators, constants, or keywords. Graphical programming objects may be associated by one or more links representing a directional dependency between respective pairs of graphical programming objects. Parameters of the graphical programming objects—such as customer or client identifier, general greeting phrase, customer greeting phrase, interaction form, language preference—may be predefined or may be configured. A validity of a functionality of the communications session flow may be determined. Based on the validity of the communications session flow, an executable programming code implementing the functionality of the communications session flow may be generated. The executable programming code may include programming code that has been compiled or interpreted into a form that may be run or deployed by the virtual receptionist platform. The executable programming code may be stored in a database of the virtual receptionist platform. The virtual receptionist platform may deploy or run the executable programming code—that is, make the executable programming code available for use via the virtual receptionist platform—such that incoming communications may be handled according to the executable programming code. Newly deployed programming code may replace previously deployed executable programming code. The virtual receptionist platform may automate the deployment of the executable programming code (for example, based on time of day), or the virtual receptionist platform may deploy the executable programming code based on a user input.

In some embodiments disclosed herein, a technical solution is provided for the technical problem of leveraging artificial intelligence (AI) techniques (for example, machine learning (ML) techniques) to generate suggested prompts for human agents to provide to customers or clients during a communications session. According to some aspects of the embodiments, a real-time transcript of a communications session between a third party (for example, a customer or client) and an automated agent of the virtual receptionist system may be generated. The communications session may be transferred from the automated agent to a queue of a human agent of the virtual receptionist system. Via a user interface, the real-time transcript may be provided to the human agent. Based on an input of the human agent (for example, clicking an “Accept” button of the user interface), a connection may be established between the third party and the human agent. Based on information associated with a profile of a customer of the virtual receptionist platform, a suggested prompt for the human agent to provide to the third party may be generated. Via the user interface, the real-time transcript may be updated with the suggested prompt.

In some embodiments disclosed herein, a technical solution is provided for the technical problem of masking an originating identifier of an agent of a virtual receptionist platform when the agent initiates or conducts communications sessions on behalf of a customer. According to some aspects of the embodiments, a plurality of identifiers (for example, telephone numbers) may be associated with an account of a customer. The virtual receptionist platform may receive, from a customer, a request for an agent of the virtual receptionist platform to conduct a communications session with a third party (for example, a client of the customer) on behalf of the customer. The request may include a selection, from one or more identifiers associated with the account of the customer, of an originating identifier for the communications session. The request may be added to a queue of an agent of the virtual receptionist platform. The virtual receptionist platform may receive, via a user interface of the agent, an acceptance of the request. Via the user interface of the agent, an originating identifier field of a communications session form may be populated with the originating identifier selected by the customer. Based on the communications session form, the communications session may be initiated using the selected originating identifier associated with the account of the customer.

Although the examples used for the various embodiments disclosed herein may include voice-based interactions, it should be readily apparent to those skilled in the art that the embodiments may extend to other forms of interaction. By way of non-limiting examples, the embodiments may extend to real-time or non-real-time communications across a wide range of communication channels, such as traditional telephony (for example, public switched telephone network (PSTN)), voice over Internet Protocol (VoIP), video conferencing, email, voicemail, live chat (for example, website support chat), text message (for example, short message service (SMS), multimedia message service (MMS)), social media messaging, and discussion forums, among others.

In particular embodiments, privacy policies may limit the types of user data that may be collected, used, or shared by particular processes of the platform or other processes (for example, internal research, ranking algorithms, machine-learning algorithms) for a particular purpose. The platform may present users with an interface indicating the particular purpose for which user data is being collected, used, or shared. The privacy policies may ensure that only necessary and relevant user data is being collected, used, or shared for the particular purpose, and may prevent such user data from being collected, used, or shared for unauthorized purposes.

### Example System Architecture

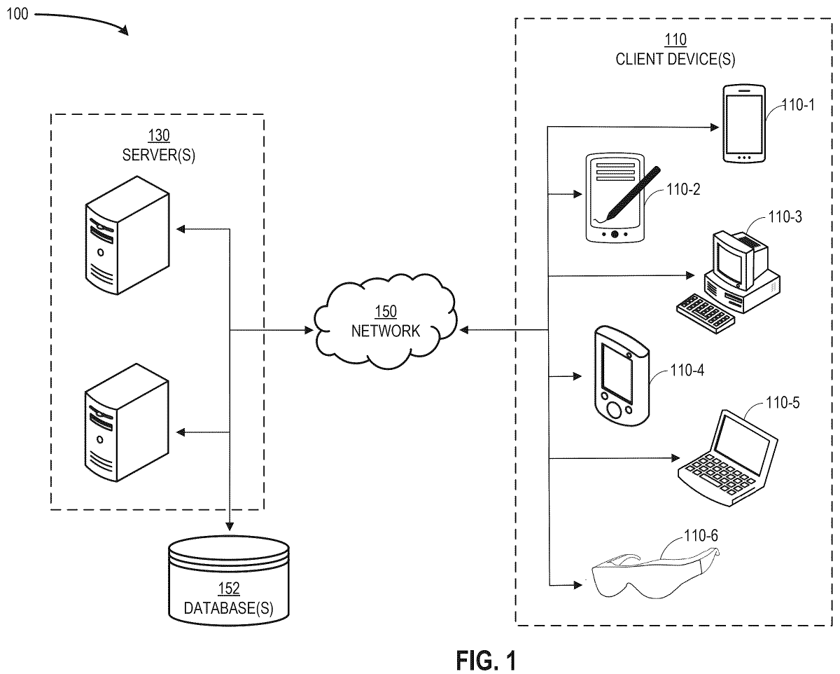

FIG. 1 illustrates a network architecture 100 suitable for providing an integrated software platform for managing virtual receptionist services, according to certain aspects of the present disclosure. Architecture 100 may include server(s) 130 and database 152, communicatively coupled with one or more client device(s) 110 via network 150.

Client device(s) 110 may include any one of laptop computer 110-5, desktop computer 110-3, or a mobile device such as smartphone 110-1, palm device 110-4, tablet device 110-2, or the like. In some embodiments, client device(s) 110 may include a headset or other wearable device 110-6. Client device(s) 110 may include a user interface that may allow a user to interact with the platform. Client device(s) 110 may be configured with a web browser or a dedicated application to facilitate communication with server(s) 130.

Server(s) 130 may include a computing device or a cluster of computing devices that may host the platform, service, or application running on client device(s) 110 used by one or more of the participants in the network. Server(s) 130 may include a cloud server or a group of cloud servers. In some implementations, server(s) 130 may not be cloud-based (that is, platforms/applications may be implemented outside of a cloud computing environment) or may be partially cloud-based. Server(s) 130 may be configured to receive requests from a client device (for example, client device(s) 110), process the requests, and send appropriate responses back to the client device. Server(s) 130 may include a database (for example, database(s) 152), for storing data, platform content, and other relevant information.

Database(s) 152 may store backup files from the platform required to run software including, for example, specific operating systems, CPU types, or installed software libraries that enable the execution of various programs on client device(s) 110. Database(s) 152 may logically form a single unit or may be part of a distributed computing environment encompassing multiple computing devices that are located within their corresponding server, located at the same, or located at geographically disparate physical locations. For example, various information related to listings, filters, localization data, user preferences, or the like may be stored in database(s) 152.

Network 150 may include, for example, any one or more of a local area network (LAN), a wide area network (WAN), the Internet, a mesh network, a hybrid network, or other wired or wireless networks. Further, network 150 may include, but is not limited to, any one or more of the following network topologies, including a bus network, a star network, a ring network, a mesh network, a star-bus network, tree or hierarchical network, and the like. Network 150 may be the Internet or some other public or private network. Client computing devices may be connected to network 150 through a network interface, such as by wired or wireless communication. The connections may be any kind of local, wide area, wired, or wireless network, including network 150 or a separate public or private network.

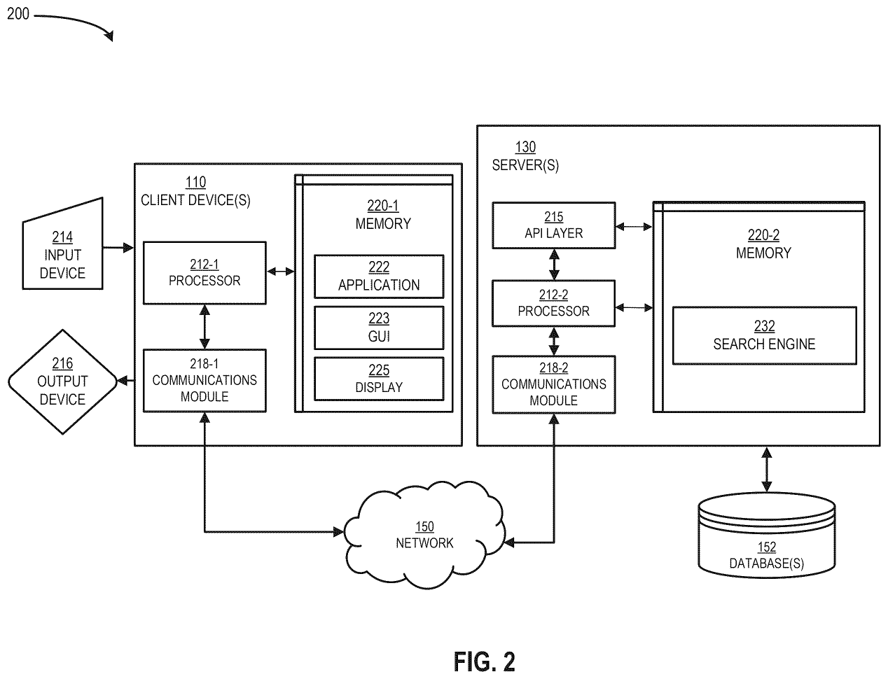

FIG. 2 is a block diagram 200 illustrating details of client device(s) 110 and server(s) 130 used in a network architecture as disclosed herein (for example, architecture 100), according to certain aspects of the present disclosure. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to transmit or receive information, such as user data, messaging history, user input data, and/or the like to other devices on network 150. Communications modules 218 may be, for example, modems or Ethernet cards, and may include radio hardware and software for wireless communications (for example, via electromagnetic radiation, such as radiofrequency (RF), near field communications (NFC), Wi-Fi, or Bluetooth radio technology).

A user may interact with client device(s) 110 via input device 214 and output device 216. Input device 214 may include a mouse, a keyboard, a pointer, a touchscreen, a wearable input device (for example, a haptics glove, a bracelet, a ring, an earring, a necklace, a watch, etc.), a microphone, a controller, a joystick, a virtual joystick, a camera, a touchscreen display that a user may use to interact with client device(s) 110, or the like. In some implementations, the user may provide search characters for a destination using input device 214. In some embodiments, input device 214 may include cameras, microphones, or sensors, such as touch sensors, acoustic sensors, inertial motion units (IMUs) and other sensors configured to provide input data. Output device 216 may include a screen display (for example, a liquid crystal display (LCD) screen and/or light emitting diode (LED) display screen), a touchscreen, a speaker, a projector, holographic or augmented reality display (for example, a heads-up display device or a head-mounted device), and/or the like.

In further examples, input device 214 and output device 216 may include biometric components, motion components, environmental components, or position components, among a wide array of other components. For example, biometric components may include components to detect expressions (for example, hand expressions, facial expressions, vocal expressions, body gestures, or eye tracking), measure biosignals (for example, blood pressure, heart rate, body temperature, perspiration, or brain waves), identify a person (for example, voice identification, retinal identification, facial identification, fingerprint identification, or electroencephalogram-based identification), or the like. The biometric components may include a brain-machine interface (BMI) system that may allow communication between the brain and an external device or machine. This may be achieved by recording brain activity data, translating the brain activity data into a format that may be understood by a computer, and then using the resulting signals to control a device or machine.

Example types of BMI technologies may include the following: electroencephalography (EEG) based BMIs, which may record electrical activity in the brain using electrodes placed on the scalp; invasive BMIs, which may use electrodes that may be surgically implanted into the brain; and optogenetics BMIs, which may use light to control the activity of specific nerve cells in the brain.

Any biometric data collected by the biometric components may be captured and stored only with user approval and deleted on user request. Further, such biometric data may be used for very limited purposes, such as identification verification. To ensure limited and authorized use of biometric information and other personally identifiable information (PII), access to such data may be restricted to authorized personnel only, if at all. Any use of biometric data may strictly be limited to identification verification purposes, and the data may not be shared or sold to any third party without the explicit consent of the user. In addition, appropriate technical and organizational measures may be implemented to ensure the security and confidentiality of such sensitive information.

In some embodiments, client device(s) 110 may include a headset or other wearable device (for example, a virtual reality or augmented reality headset or smart glass). In various implementations, client device(s) 110 may communicate over wired or wireless channels to distribute processing and/or share data. Architecture 100 may create, administer, or provide interaction modes for a shared artificial reality environment (for example, a collaborative artificial reality environment) at client device(s) 110, such as for communication via extended reality (XR) or other communication elements. The interaction modes may include various modes for various audio conversation, textual input/output, communicative gestures, control modes, and other communicative interaction, etc., for each user of client device(s) 110.

Client device(s) 110 may also include processor 212-1, configured to execute instructions stored in memory 220-1, and to cause client device(s) 110 to perform at least some operations in methods consistent with one or more embodiments. Some operations may be offloaded to a core processing component or to server(s) 130. Memory 220-1 may further include application 222 and display 225, configured to run in client device(s) 110 and couple with input device 214 and output device 216. Application 222 may be downloaded by the user from server(s) 130 or may be hosted by server(s) 130. Application 222 may include specific instructions which, when executed by processor 212-1, cause operations to be performed according to methods described herein. In some embodiments, application 222 may run on a platform, for example, an operating system (OS) installed in client device(s) 110. In some embodiments, application 222 may run out of a web browser. In some embodiments, processor 212-1 may be configured to control graphical user interface (GUI) 223 or display 225 for the user of one of client device(s) 110 accessing the server of the platform. Data and files associated with application 222 may be stored in database(s) 152.

Server(s) 130 may include memory 220-2, processor 212-2, and communications module 218-2. Hereinafter, processors 212-1 and 212-2, and memories 220-1 and 220-2, will be collectively referred to, respectively, as “processors 212” and “memories 220.” In some implementations, server(s) 130 may be used as part of a social network/platform implemented via the network 150. Processors 212 (for example, CPUs, GPUs, holographic processing units (HPUs), etc.) may be configured to execute instructions stored in memories 220. Processors 212 may be a single processing unit or multiple processing units in a device or distributed across multiple devices (for example, distributed across two or more of client device(s) 110). Processors 212 may be coupled to other hardware devices, for example, with the use of an internal or external bus, such as a peripheral component interconnect (PCI) bus, small computer system interface (SCSI) bus, wireless connection, and/or the like. Processors 212 may communicate with a hardware controller for devices, such as input device 214 and output device 216.

Memories 220 may include one or more hardware devices for volatile or non-volatile storage, and memories 220 may include both read-only and writable memory. For example, a memory may include one or more of random-access memory (RAM), various caches, CPU registers, read-only memory (ROM), and writable non-volatile memory, such as flash memory, hard drives, floppy disks, CDs, DVDs, magnetic storage devices, tape drives, and so forth. Memories 220 may not propagate signals divorced from underlying hardware; thus, a memory may be non-transitory. Memories 220 may include program memory that stores programs or software. Memories 220 may also include data memory that may include information to be provided to the program memory or any element of the network.

Memory 220-2 may include search engine 232 which may share or provide features and resources to display 225, including multiple tools associated with text, image, or video collection and capture. Such tools may support design or development applications that use text or images retrieved (for example, at application 222) for content rendering to a user of client device(s) 110. This may enable the platform to present listings, user reviews, and other relevant content effectively to the user. The user may access search engine 232 through application 222, installed in memory 220-1 of client device(s) 110. Accordingly, application 222, including display 225, may be installed by server(s) 130 and perform scripts or other routines provided by servers 130 through any one of multiple tools. Server(s) 130 may include application programming interface (API) layer 215, which may control applications in client device(s) 110. API layer 215 may also provide tutorials to users of client device 110 as to new features in application 222. Search engine 232 may include one or more sets of machine-readable instruction modules that, when executed by processors 212, are configured to perform operations according to one or more aspects of embodiments described herein.

Some implementations may be operational with numerous other computing system environments or configurations. Examples of computing systems, environments, and/or configurations that may be suitable for use with the technology include, but are not limited to, extended reality (XR) headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

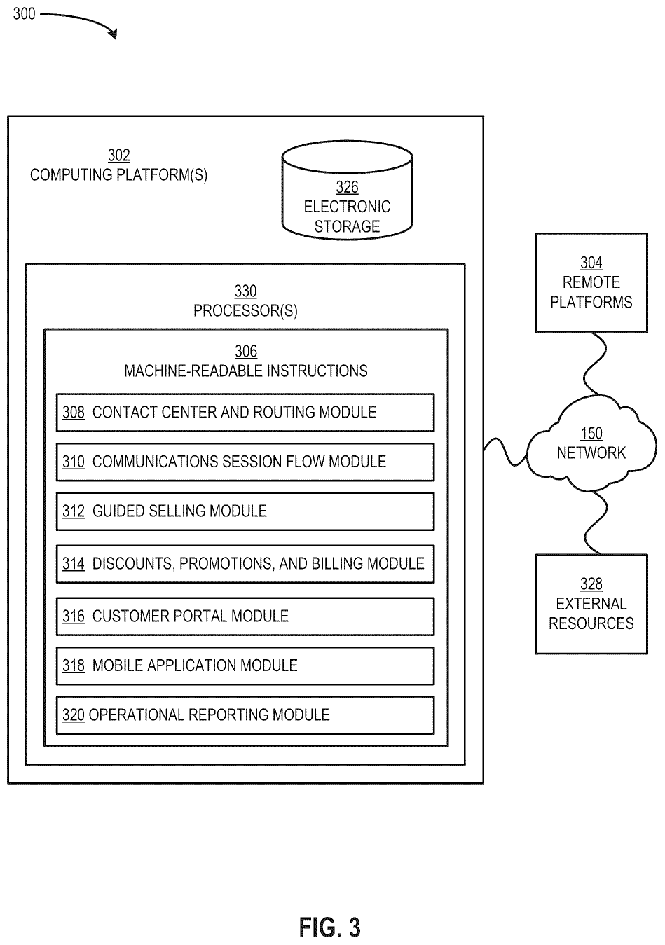

FIG. 3 is a block diagram illustrating an example system 300 (for example, representing both client and server) with which aspects of the subject technology may be implemented. System 300 may be configured to provide for an integrated software platform for managing virtual receptionist services, according to certain aspects of the disclosure. In some implementations, system 300 may include one or more computing platform(s) 302. For example, computing platform(s) 302 may be configured to execute software algorithm(s) to encode, compress, decompress, or reconstruct text or image data.

Computing platform(s) 302 may maintain or store data, such as in electronic storage 326, including correlation, contextual data, or metadata used by computing platform(s) 302. Computing platform(s) 302 may be configured to communicate with one or more remote platform(s) 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300, which may host one or more application(s), for example, via remote platform(s) 304. In this way, remote platform(s) 304 may be configured to cause output of system 300 on client device(s) of remote platform(s) 304 with enabled access (for example, based on analysis by computing platform(s) 302, according to the stored data).

Computing platform(s) 302 may be configured by machine-readable instructions 306. Machine-readable instructions 306 may be executed by computing platform(s) 302 to implement one or more instruction modules. The instruction modules may include computer program modules. The instruction modules being implemented may include one or more of contact center and routing module 308; communications session flow module 310; guided selling module 312; discounts, promotions, and billing module 314; customer portal module 316; mobile application module 318; and operational reporting module 320.

Contact center and routing module 308 may be configured to streamline and manage inbound or outbound communications. Contact center and routing module 308 may include features to handle a high volume of communications (for example, telephone calls), to route communications to an appropriate agent or group of agents (for example, human agents or automated agents), or to provide analytics to improve performance. Components or functionalities of contact center and routing module 308 may include a unified interface, an omnichannel support component, a communications session distribution component, an interactive voice response (IVR) component, a queue management component, a real-time monitoring and analytics component, a logging and reporting component, a user identification and history component, or a failover routing component.

The unified interface may include a dashboard for agents (for example, human agents or automated agents) to manage telephone calls, emails, chats, or other communication channels. The unified interface may integrate with customer relationship management (CRM) systems to provide agents access to user (for example, customer, client) information or history. The omnichannel support component may enable the handling of multiple communication channels, including voice calls, emails, live chat, social media, or text messaging, to allow agents to engage with users across various devices and touchpoints. The communications session distribution component (for example, an automatic call distribution (ACD) component) may enable the distribution of incoming communications sessions to the most appropriate agent based on predefined criteria (for example, agent availability, agent skill set, customer priority, client priority). An interactive voice response (IVR) component may allow users to interact with a computerized menu system using voice or text inputs. The IVR component may direct a communications session to an appropriate agent or group of agents or may provide self-service options to handle common inquiries. A queue management component may manage communication queues, informing an agent or a user of a position of the user in the queue and an estimated wait time. The queue management component may offer callback options to avoid long wait times for users. The real-time monitoring and analytics component may provide real-time dashboards and reports on communications session volume, average handling time, wait times, and agent performance. The real-time monitoring and analytics component may allow supervisors to monitor live communications sessions and provide coaching or intervention if needed. The logging and reporting component may record communications sessions for quality assurance, training, or compliance purposes. The logging and reporting component may log detailed communications session information for future reference and analysis.

Contact center and routing module 308 may be configured to route communications based on a specific skill or set of skills required to handle an inquiry of a user (for example, a customer, a client), ensuring the user is connected to the most qualified agent. In some embodiments, contact center and routing module 308 may be configured to route communications based on priority. For example, a high-priority communication (for example, a communication involving a VIP user or involving an urgent issue) may be routed to (or near) the front of the queue or to a specialized agent. In some embodiments, contact center and routing module 308 may be configured to route communications sessions based on geographic location. For example, communications sessions may be routed based on a geographic location of the user or the agent. In some embodiments, contact center and routing module 308 may be configured to route communications based on time of day, ensuring communications are directed to the appropriate agent or group of agents that are available during specific hours. The user identification (ID) and history component may use caller ID (or the like) or CRM integration to identify the user (for example, customer, client) and to route the user based on previous interactions of the user with the virtual receptionist platform. The failover routing component may ensure communications sessions are rerouted to alternative agents or locations in case of system failures or high communications session volumes, maintaining continuity of service.

Communications session flow module 310 may be configured to design, implement, edit, or optimize communications handling workflows. In some embodiments, communications session flow module 310 may enable an agent or a customer to create workflows or to customize system-generated workflows for handling incoming or ongoing communications sessions, ensuring that each communications session is directed to the appropriate agent or group of agents. Components or functionalities of communications session flow module 310 may include a workflow design interface, a routing rules component, a greetings and messages component, a conditional logic and branching component, a testing and simulation component, or a performance reporting component.

The workflow design interface may include a graphical user interface (for example, a drag-and-drop builder) that allows agents or customers to visually design communications session flows (for example, telephone call flows) by selecting and arranging flow elements such as menus, prompts, routing rules, and routing options. The workflow design interface may include flow templates for common scenarios, which may be customized to fit the specific needs of a customer. The routing rules component may generate or may enable an agent or a customer to select, customize, or define routing rules. The greetings and messages component may enable a customer to create a customized prompt that may be provided to a client (for example, via a human agent or via automated voice or text output) or may enable a customer to choose or upload hold music or informational messages to play while a client is on hold. The conditional logic and branching component may generate or may suggest to an agent or a customer conditional logic to route communications sessions based on specific criteria, such as a customer or client input, an account status of a customer or a client of the customer, or a previous interaction of the customer or the client of the customer with the virtual receptionist platform. The conditional logic and branching component may generate or may suggest to an agent or a customer multiple paths within the communications session flow to handle different types of inquiries or customer or client needs. The testing and simulation component may simulate communications sessions through a designed flow to test and refine the flow before implementing the flow. The testing and simulation component may include debugging tools to identify and fix issues within the flow to ensure smooth operation. The performance reporting component may generate reports to evaluate the effectiveness of a communications session flow and identify areas for improvement.

Guided selling module 312 may be configured to assist an agent in providing personalized product or service recommendations and sales guidance to customers, wherein a product or service may be associated with the virtual receptionist platform (for example, voicemail services). In some embodiments, guided selling module 312 may be configured to assist an agent in providing personalized product or service recommendations to clients, wherein a product or service is associated with the customer (for example, medical products or services of a healthcare provider customer). Guided selling module 312 may leverage real-time data, decision-making tools, or interactive features to enhance the sales process and improve user (for example, customer, client) satisfaction. Components or functionalities of guided selling module 312 may include an interactive decision support component, a real-time data integration component, a handoff component, or a sales insights component.

The interactive decision support component may provide an agent with a series of questions or scripts to gather information about the needs, preferences, or budget of a user (for example, customer, client). The interactive decision support component may utilize decision trees to guide an agent through various scenarios and recommend products or services based on user responses.

The real-time data integration component may integrate with a product database of a customer to provide up-to-date information on products or services, including features, availability, or pricing. The real-time data integration component may pull relevant user data from CRM systems to personalize interactions and recommendations. The handoff component may enable an agent to transfer a user to another agent or group of agents if needed. The handoff component may ensure that all information gathered during an interaction with a first agent is passed on to a second agent, providing a smooth transition and continuity. The sales insights component may track key metrics such as conversion rates, product recommendations, customer or client feedback, lead volume, communications session type analysis, or handle time. The sales insights component may provide insights into user preferences and behavior to help refine sales strategies or improve product offerings.

Discounts, promotions, and billing module 314 may be configured to streamline the application of discounts, manage promotions, and handle billing inquiries efficiently. Discounts, promotions, and billing module 314 may equip agents with the necessary tools to provide accurate and timely information, process transactions, and enhance user satisfaction. Components or functionalities of discounts, promotions, and billing module 314 may include a discounts and promotions management component, a billing inquiries component, or a user account management component.

The discounts and promotions management component may provide an agent with real-time information on current discounts, promotions, or special offers. The discounts and promotions management component may enable an automatic application of eligible discounts and promotions during transactions and may allow the creation and management of custom promotions tailored to specific customer segments or seasonal events. The billing inquiries component may assist agents in handling customer inquiries related to billing, payment status, or account balances. The billing inquiries component may generate or send invoices to customers, including detailed breakdowns of charges and applied discounts. The billing inquiries component may facilitate secure payment processing through various payment methods, such as cash, credit/debit cards, bank transfers, mobile payments, digital wallets, or other payment gateways. The user account management component may provide an agent with access to user account details, including billing history, payment methods, or outstanding balances. The user account management component may manage user subscriptions, including upgrades, downgrades, or renewals.

Discounts, promotions, and billing module 314 may ensure seamless integration with CRM or enterprise resource planning (ERP) systems to keep user and billing information up to date and may automatically update transaction records and billing details in the integrated systems.

Customer portal module 316 may be configured to provide customers with a self-service interface to manage interactions with the virtual receptionist platform, access information, or perform various tasks, including onboarding, communications session flow configuration, account management, or the like.

Mobile application module 318 may be configured to extend the functionalities of the virtual receptionist platform to mobile devices, providing users (for example, agents, clients, customers) with convenient, on-the-go access to essential features and services.

Operational reporting module 320 may be configured to provide detailed insights and analytics on the performance and operations of the virtual receptionist platform. Operational reporting module 320 may enable a virtual receptionist platform or an agent of the virtual receptionist platform to monitor key metrics, analyze trends, and make data-driven decisions to improve efficiency and user satisfaction. Components or functionalities of operational reporting module 320 may include a dashboard, an agent activity tracking component, or a user interactions component.

The dashboard may display key metrics and performance indicators in real time for immediate insights. Key metrics may include the following: communications sessions volume, which may track the number of incoming, outgoing, or missed communications sessions; communications session duration, which may track average communications session duration or total talk (or type) time; and communications session wait time, which may track average and maximum wait times for users (for example, customers, clients). An agent may be allowed to customize the dashboard to display the most relevant information for the needs of the agent or a user. The agent activity tracking component may report on the number of communications sessions handled by an agent, the average time taken to answer an initial or a subsequent user message, or the percentage of user inquiries resolved on the first interaction. The user interactions component may collect and analyze user satisfaction ratings and feedback and may provide detailed logs of user interactions, including notes and follow-up actions. The user interactions component may identify peak communications session times, analyze trends over time, or use historical data to predict future communications session volumes and resource needs. The operational reporting module may be configured to enable agents to create custom reports tailored to specific operational needs or to enable automatic generation and distribution of reports at specified intervals.

In some embodiments, artificial intelligence (AI) technologies may be leveraged to interpret a user query (for example, a voice input) and to provide an agent with AI-generated insight (for example, sentiment analysis, response suggestion) or information related to the user query. An agent may reference the AI-generated insight or information to provide the user (for example, customer, client) with a more accurate and detailed response and to provide the response more efficiently.

In some embodiments, an agent may include an automated agent (for example, an interactive voice response (IVR) system, or a virtual assistant, which may leverage AI technologies, such as natural language processing (NLP) or large language models (LLMs)) that may handle a communications session with a user (for example, customer, client) alone or in collaboration with a human agent. A handoff may be executed between the automated agent and the human agent.

In some embodiments, a portal (for example, a client portal, a customer portal, an agent portal) may include access to an automated assistant capable of responding to a query (for example, about the portal, about the account of the user), capable of directing a user to an internal or external page with information associated with the query, or of assisting with scheduling statuses.

In some implementations, computing platform(s) 302, remote platform(s) 304, and/or external resources 328 may be operatively linked via one or more electronic communication links. For example, such electronic communication links may be established, at least in part, via network 150 such as the Internet and/or other networks. It will be appreciated that this is not intended to be limiting, and that the scope of this disclosure includes implementations in which computing platform(s) 302, remote platform(s) 304, and/or external resources 328 may be operatively linked via some other communication media.

A given remote platform(s) 304 may include client computing devices, such as a first client device or second client device, which may each include one or more processors configured to execute computer program modules (for example, the instruction modules). The computer program modules may be configured to enable an expert or user associated with the given remote platform to interface with system 300 and/or external resources 328, and/or provide other functionality attributed herein to remote platform(s) 304. By way of non-limiting example, a given remote platform(s) 304 and/or a given computing platform(s) 302 may include one or more of a server, a desktop computer, a laptop computer, a handheld computer, a tablet computing platform, a NetBook, a smartphone, a gaming console, and/or other computing platforms. External resources 328 may include sources of information outside of system 300, external entities participating with the system 300, and/or other resources.

Computing platform(s) 302 may include electronic storage 326, one or more processor(s) 330, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to the computing platform(s) 302. For example, computing platform(s) 302 may be implemented by a cloud of computing platforms operating together as computing platform(s) 302.

Electronic storage 326 may comprise non-transitory storage media that electronically stores information. Electronic storage media of electronic storage 326 may include one or both of system storage that is provided integrally (that is, substantially non-removable) with computing platform(s) 302 and/or removable storage that is removably connectable to computing platform(s) 302 via, for example, a port (for example, a USB port, a firewire port, etc.) or a drive (for example, a disk drive, etc.). Electronic storage 326 may include one or more of optically readable storage media (for example, optical disks, etc.), magnetically readable storage media (for example, magnetic tape, magnetic hard drive, floppy drive, etc.), electrical charge-based storage media (for example, EEPROM, RAM, etc.), solid-state storage media (for example, flash drive, etc.), and/or other electronically readable storage media. Electronic storage 326 may include one or more virtual storage resources (for example, cloud storage, a virtual private network, and/or other virtual storage resources). Electronic storage 326 may store software algorithms, information determined by processor(s) 330, information received from computing platform(s) 302, information received from remote platform(s), and/or other information that enables computing platform(s) 302 to function as described herein.

Processor(s) 330 may be configured to provide information processing capabilities in computing platform(s) 302. As such, processor(s) 330 may include one or more of a digital processor, an analog processor, a digital circuit designed to process information, an analog circuit designed to process information, a state machine, and/or other mechanisms for electronically processing information. Although processor(s) 330 is shown in FIG. 3 as a single entity, this is for illustrative purposes only. In some implementations, processor(s) 330 may include a plurality of processing units. These processing units may be physically located within the same device, or processor(s) 330 may represent processing functionality of a plurality of devices operating in coordination. Processor(s) 330 may be configured to execute modules 308, 310, 312, 314, 316, 318, and/or 320, and/or other modules. Processor(s) 330 may be configured to execute modules 308, 310, 312, 314, 316, 318, and/or 320, and/or other modules by software; hardware; firmware; some combination of software, hardware, and/or firmware; and/or other mechanisms for configuring processing capabilities on processor(s) 330. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, and/or 320 are illustrated in FIG. 3 as being implemented within a single processing unit, in implementations in which processor(s) 330 includes multiple processing units, one or more of modules 308, 310, 312, 314, 316, 318, and/or 320 may be implemented remotely from the other modules. The description of the functionality provided by the different modules 308, 310, 312, 314, 316, 318, and/or 320 described below is for illustrative purposes, and is not intended to be limiting, as any of modules 308, 310, 312, 314, 316, 318, and/or 320 may provide more or less functionality than is described. For example, one or more of modules 308, 310, 312, 314, 316, 318, and/or 320 may be eliminated, and some or all of its functionality may be provided by other ones of modules 308, 310, 312, 314, 316, 318, and/or 320. As another example, processor(s) 330 may be configured to execute one or more additional modules that may perform some or all of the functionality attributed below to one of modules 308, 310, 312, 314, 316, 318, and/or 320.

### I. Agent Management

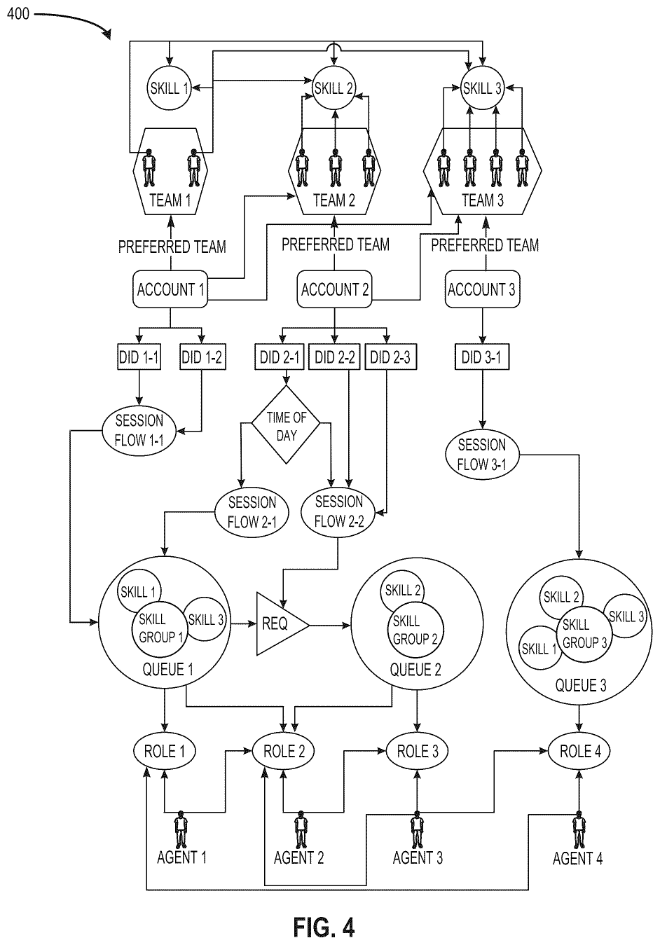

FIG. 4 illustrates a flowchart representing an example process 400 for communications session handling by a virtual receptionist system, according to certain aspects of the present disclosure. Process 400 illustrates how incoming communications (for example, telephone calls, text messages, emails) may be routed or handled based on agent skill, agent team, customer account, direct inward dialing (DID) number, communications session flow, queue, agent skill group, or agent role.

As shown in process 400, one or more skills may be defined for agents of the virtual receptionist system (for example, SKILL 1, SKILL 2, and SKILL 3 in FIG. 4). By way of non-limiting examples, agent skills may include communication skills, technical or function skills, communications session handling skills, technical expertise, security or compliance knowledge, customer (or client) service skills, or availability or time-based skills. Communication skills may include language proficiency (for example, English, Spanish, or French), accent neutrality, or clear articulation. Communications session handling skills may include screening, transferring, voicemail management, or live call answering. Technical expertise skills may include knowledge of legal terminology, medical terminology, or real estate processes. Security or compliance knowledge skill may include knowledge of confidentiality conditions or privacy standards. Customer (or client) service skills may include conflict resolution, problem solving, upselling or lead qualification.

A skill may be associated with a team (for example, TEAM 1, TEAM 2, TEAM 3 in FIG. 4) that specializes in handling calls requiring a particular skill or set of skills. For example, as shown in FIG. 4, agents of TEAM 1 may be associated with SKILLS 1, 2, and 3; agents of TEAM 2 may be associated with only SKILL 2; and agents of TEAM 3 may be associated with only SKILL 3.

An account of a customer may be associated with a preferred team, such that incoming calls from either the customer or a client of the customer may be routed to a preferred team. For example, as shown in FIG. 4, the preferred teams of ACCOUNT 1 include TEAMS 1, 2, and 3; the preferred teams of ACCOUNT 2 include TEAMS 2 and 3; and the preferred team of ACCOUNT 3 includes TEAM 3. If an account is associated with multiple physical locations or identifiers (for example, telephone numbers), then the virtual receptionist system may route a communications session to a team associated with a particular location or identifier, overriding the preferred team. For example, if an account is associated with a particular country or a particular telephone area code, then the virtual receptionist system may route a communications session to a team associated with the particular country or the particular telephone area code, overriding the preferred team of the account. The virtual receptionist system may prioritize routing a communications session to an agent matching a team. If multiple agents are associated with a team, then the agent that has waited the longest since last conducting a communications session may be assigned a communications session first.

The virtual receptionist system may maintain, via a database of the virtual receptionist system, one or more telephone number tables to fetch the details of telephone numbers associated with an account of a customer. The virtual receptionist system may select telephone numbers from one or more telephone numbers allocated by the virtual receptionist system or by a third-party platform. The virtual receptionist system may remove the one or more telephone numbers from the database of the virtual receptionist system without removing the one or more telephone numbers from the third-party platform, allowing the one or more telephone numbers to be reallocated. Account-level telephone numbers may be unique telephone numbers. In some embodiments, account-level telephone numbers may be provided by a customer. In some embodiments, account-level telephone numbers may be allocated by the virtual receptionist system or by a third-party platform. An account-level telephone number may be configured with parameters such as a skill group, communications session flow, or interactive voice response (IVR) script.

Each account may be associated with one or more direct inward dialing (DID) numbers, which may include unique telephone numbers that route communications sessions to specific agents or teams, or according to specific logic, of the virtual receptionist system. For example, as shown in FIG. 4, ACCOUNT 1 may be associated with DID 1-1 and DID 1-2; ACCOUNT 2 may be associated with DID 2-1, DID 2-2, and DID 2-3; and ACCOUNT 3 may be associated with DID 3-1. The virtual receptionist system may use a DID to identify a source or a purpose of an inbound communication.

The virtual receptionist system may route a communications session based on time of day. For example, during business hours, the virtual receptionist system may route an inbound communication to a human agent. After business hours, the virtual receptionist system may route an inbound communication to an automated agent (for example, a voicemail system, an interactive voice response (IVR) system, or a virtual assistant, which may leverage artificial intelligence (AI) technologies, such as natural language processing (NLP) or large language models (LLMs)) or to an alternative team.

Based on at least one of a DID and time of day, the virtual receptionist system may route a communications session according to a communications session flow. A communications session flow may include a predefined logic path that dictates how a communications session should be handled. For example, inbound communications associated with DID 1-1 and DID 1-2 may be handled according to SESSION FLOW 1-1. Inbound communications associated with DID 2-1 and a first TIME OF DAY may be handled according to SESSION FLOW 2-1; inbound communications associated with DID 2-1 and a second TIME OF DAY may be handled according to SESSION FLOW 2-2; and inbound communications associated with DID 2-2 or DID 2-3 may be handled according to SESSION FLOW 2-2. Inbound communications associated with DID 3-1 may be handled according to SESSION FLOW 3-1.

An agent may be associated with a role (for example, administrator, receptionist, sales representative), which may enable switchable job functions. For example, the virtual receptionist system may enable an agent to switch between a receptionist role and a sales representative role. In FIG. 4, AGENT 1 is assigned ROLE 1 and ROLE 2; AGENT 2 is assigned ROLE 2 and ROLE 3; AGENT 3 is assigned ROLE 2, ROLE 3, and ROLE 4; and AGENT 4 is assigned ROLE 1 and ROLE 4. In an agent portal of an application associated with a virtual receptionist system, an agent with multiple roles assigned to the agent may switch roles via, for example, a dropdown menu or a settings menu of the application. Switching roles may change the user interface and the available features of the application based on a selected role. For example, an administrator view may have access to system configuration features, and a receptionist view may have access to telephone call handling features. The communications sessions routed to an agent may change according to an active role. In some embodiments, roles may be used to define access privileges (for example, an administrator role may have higher access privileges than a receptionist role). In some embodiments, the access privileges of an agent may be consistent with the highest access privileges of a role of the agent. For example, an administrator role may have higher access privileges than a receptionist role. If an agent is assigned an administrator role and a receptionist role, then the agent may switch from an administrator role to a receptionist role while maintaining the higher access privileges of the administrator role. Switching roles may change the communications sessions routed to the agent without changing the higher access privileges of the agent.

Communications sessions may be placed in queues associated with a skill group, ensuring communications sessions are handled by agents with appropriate expertise. A skill group (for example, SKILL GROUP 1, SKILL GROUP 2, and SKILL GROUP 3 in FIG. 4) may include a collection of skills that may be used to match an agent with a communications session. In some embodiments, an agent must have all of the skills in a skill group in order to be matched with a queue associated with the skill group. In some embodiments, a skill group may be assigned to a telephone number associated with an account. An inbound communication originating from the telephone number associated with the account may be routed to the skill group and to any available agents who match with all of the skills associated with the skill group.

A queue (for example, QUEUE 1, QUEUE 2, and QUEUE 3 of FIG. 4) may be assigned one (1) skill group, allowing for prioritization of communications session routing or at least one (1) skill. In some embodiments, queue parameters may include role priority, reservation timeout, queue timeout, timeout priority, or queuing style. Using role priority, a numerical value may be set for each role to prioritize calls to particular roles. In some embodiments, the higher the numerical value, the higher the priority. Multiple roles may have the same numerical value, meaning the multiple roles may be equally prioritized. For example, a receptionist queue may have a receptionist role as a higher priority with an arbitrary numerical value of one hundred (100), and the receptionist queue may have a customer service role as a lower priority with an arbitrary numerical value of fifty (50), which is less than one hundred (100). Reservation timeout may include the number of seconds to wait for an agent to respond to an inbound communication before moving to another available agent. Queue timeout may include the number of seconds to wait before a priority of a communications session is increased. Timeout priority may include how much to increase the priority when a queue timeout occurs. Queuing style may determine what sound is played while a telephone call is in queue. For example, a ringing sound may be played until initial contact with an agent, or a song may be played until initial contact with an agent or while on hold after initial contact with an agent.

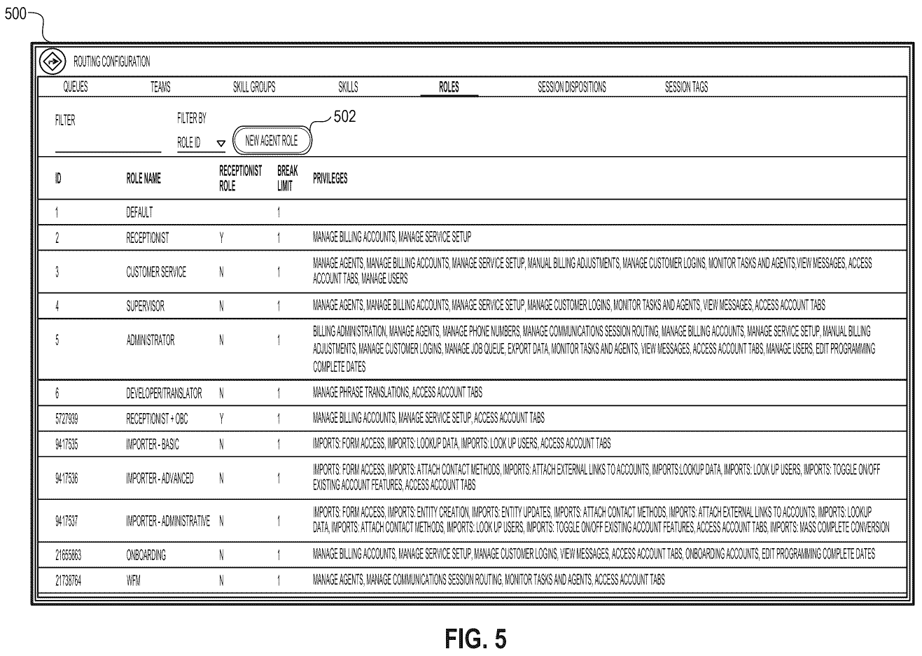

FIG. 5 illustrates display 500 of an example graphical user interface for defining roles of agents of a virtual receptionist system, according to certain aspects of the present disclosure. Under a ROLES tab of a ROUTING CONFIGURATION window, display 500 may include interactive element 502 (NEW AGENT ROLE button). A user interaction (for example, clicking, hovering, swiping) with interactive element 502 may open a window (for example, a pop-up window) or a panel enabling a user (for example, an administrator of the virtual receptionist system) to input a name and a set of privileges for a new agent role. The user may also indicate whether the new role includes a receptionist role. An identifier (for example, a numerical identifier) may be assigned to a new role by the virtual receptionist system. As shown in FIG. 5, example role names may include, but are not limited to, RECEPTIONIST, CUSTOMER SERVICE, SUPERVISOR, ADMINISTRATOR, or DEVELOPER/TRANSLATOR. As shown in FIG. 5, privileges of a receptionist may include managing billing accounts and managing service setup. A user interaction (for example, clicking, hovering, swiping) with a row of an existing role may open a window (for example, a pop-up window) or a panel enabling a user to edit parameters of the existing role.

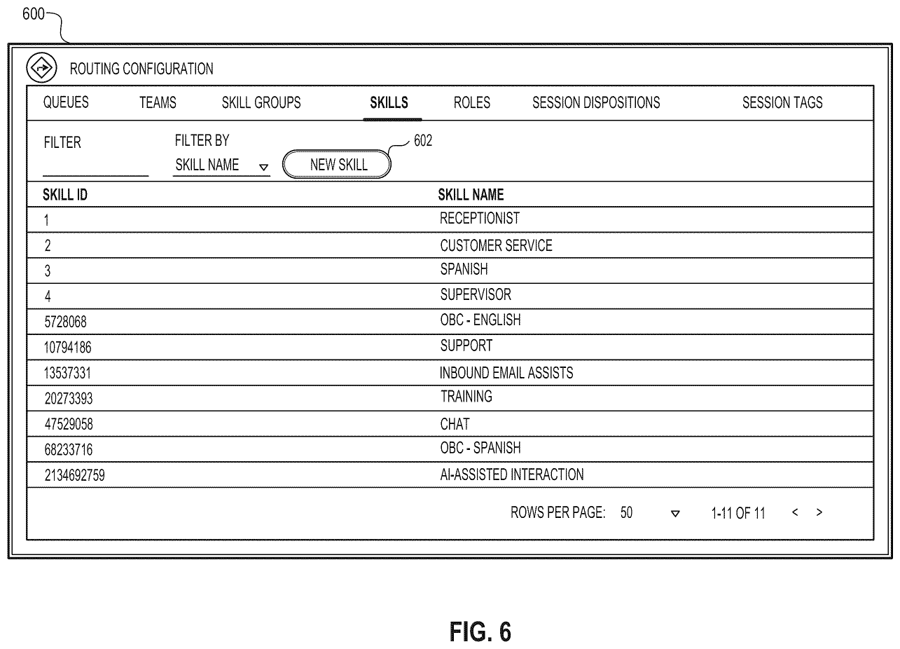

FIG. 6 illustrates display 600 of an example graphical user interface for defining skills of agents of a virtual receptionist system, according to certain aspects of the present disclosure. Under a SKILLS tab of a ROUTING CONFIGURATION window, display 600 may include interactive element 602 (NEW SKILL button). A user interaction with interactive element 602 may open a window (for example, a pop-up window) or a panel enabling a user (for example, an administrator of the virtual receptionist system) to input a name for a new skill. An identifier (for example, a numerical identifier) may be assigned to a new skill by the virtual receptionist system. As shown in FIG. 6, example skill names may include SPANISH, SUPPORT, TRAINING, and CHAT. A user interaction (for example, clicking, hovering, swiping) with a row of an existing skill may open a window (for example, a pop-up window) or a panel enabling a user to edit parameters of the existing skill.

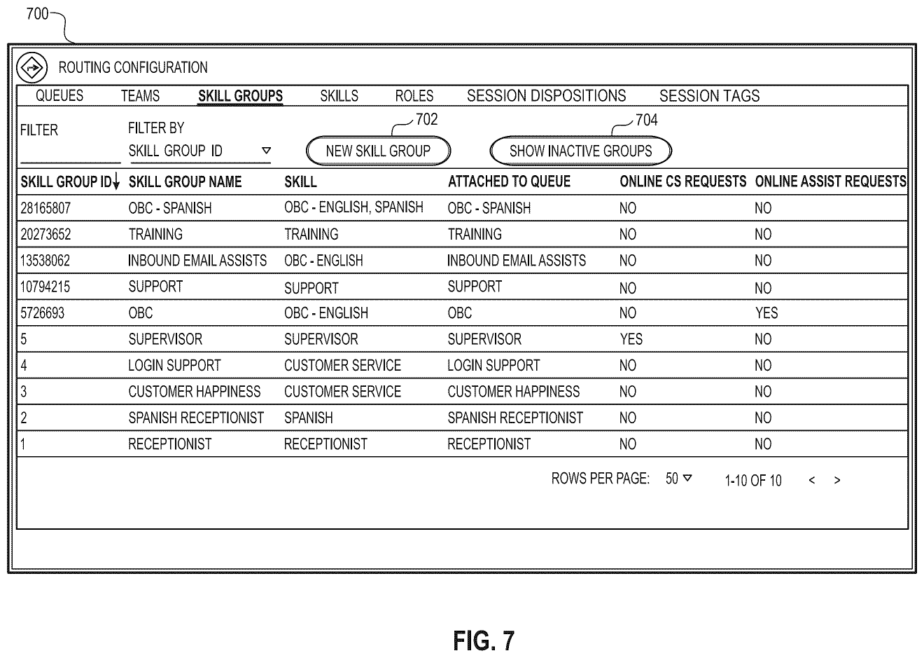

FIG. 7 illustrates display 700 of an example graphical user interface for defining skill groups of agents of a virtual receptionist system, according to certain aspects of the present disclosure. Under a SKILL GROUPS tab of a ROUTING CONFIGURATION window, display 700 may include interactive element 702 (NEW SKILL GROUP button) and interactive element 704 (SHOW INACTIVE GROUPS button). A user interaction (for example, clicking, hovering, swiping) with interactive element 702 may open a window (for example, a pop-up window) or a panel enabling a user (for example, an administrator of the virtual receptionist system) to input a name, skill, or queue for a new skill group. An identifier (for example, a numerical identifier) may be assigned to a new skill group by the virtual receptionist system. A user interaction (for example, clicking, hovering, swiping) with interactive element 704 may open a window (for example, a pop-up window) or a panel enabling a user (for example, an administrator of the virtual receptionist system) to view a list of inactive skill groups. As shown in FIG. 7, example skill group names may include INBOUND EMAIL ASSISTS, LOGIN SUPPORT, or CUSTOMER HAPPINESS. Skill group LOGIN SUPPORT may be associated with skill CUSTOMER SERVICE and may be attached to queue LOGIN SUPPORT. A user interaction (for example, clicking, hovering, swiping) with a row of an existing skill group may open a window (for example, a pop-up window) or a panel enabling a user to edit parameters of the existing skill group.

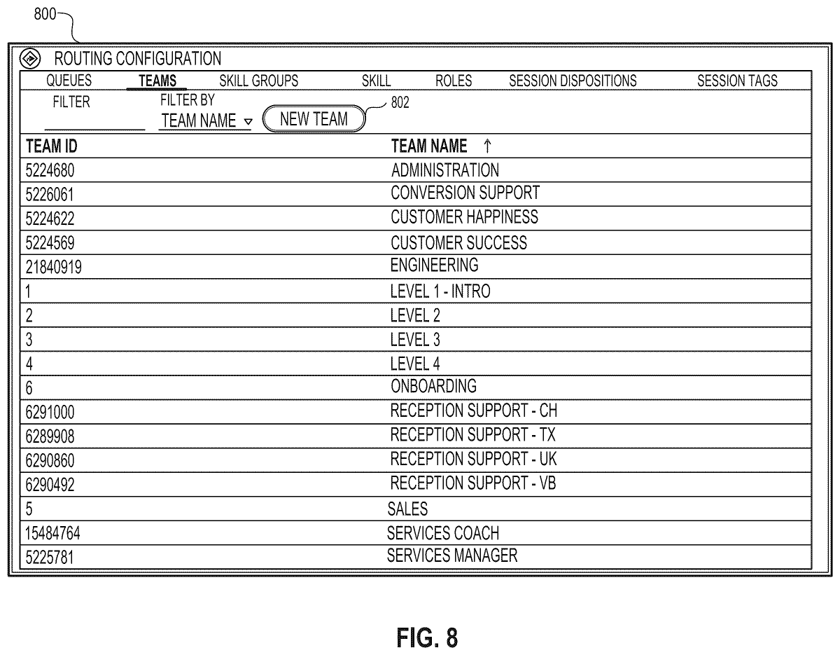

FIG. 8 illustrates display 800 of an example graphical user interface for defining teams of agents of a virtual receptionist system, according to certain aspects of the present disclosure. Under a TEAMS tab of a ROUTING CONFIGURATION window, display 800 may include interactive element 802 (NEW TEAM button). A user interaction (for example, clicking, hovering, swiping) with interactive element 802 may open a window (for example, a pop-up window) or a panel enabling a user (for example, an administrator of the virtual receptionist system) to input a name for a new team. An identifier (for example, a numerical identifier) may be assigned to a new team by the virtual receptionist system. As shown in FIG. 8, example team names may include ADMINISTRATION, CONVERSION SUPPORT, ENGINEERING, and RECEPTION SUPPORT—TEXAS (TX). A user interaction (for example, clicking, hovering, swiping) with a row of an existing team may open a window (for example, a pop-up window) or a panel enabling a user to edit parameters of the existing team.

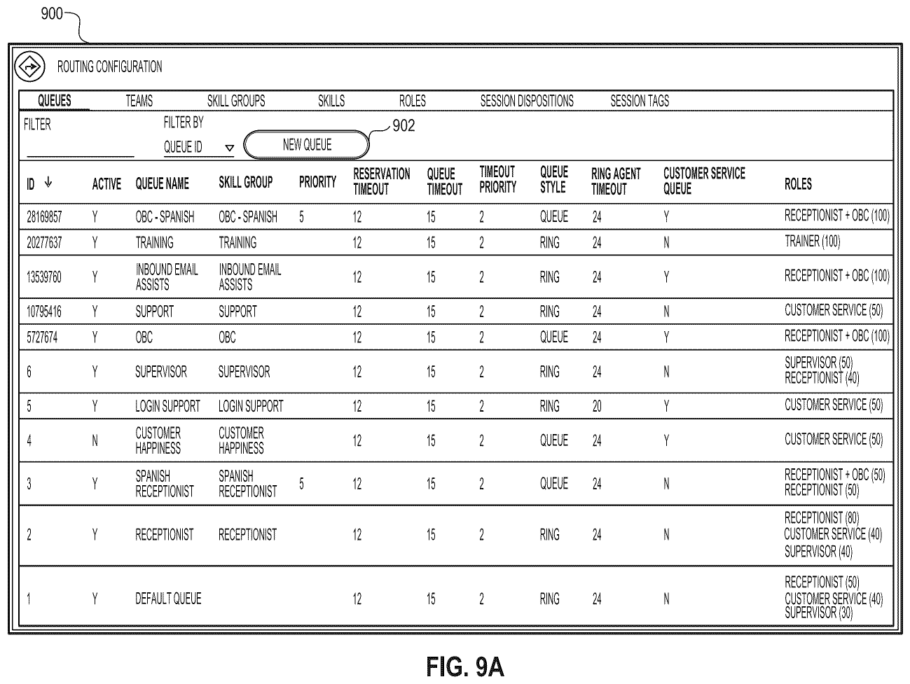

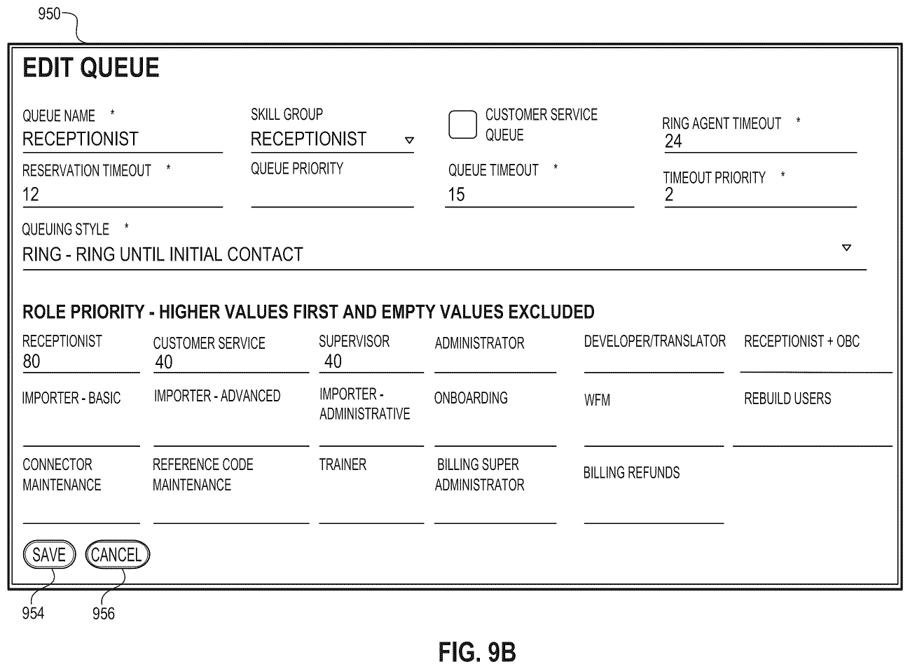

FIGS. 9A and 9B illustrate display 900 and display 950 of an example graphical user interface for defining queues of agents of a virtual receptionist system, according to certain aspects of the present disclosure. As shown in FIG. 9A, under a QUEUES tab of a ROUTING CONFIGURATION window, display 900 may include interactive element 902 (NEW QUEUE button). A user interaction (for example, clicking, hovering, swiping) with interactive element 902 may open display 950, of FIG. 9B, which may enable a user (for example, an administrator of the virtual receptionist system) to input parameters for a queue. Display 950 may include interactive element 954 (SAVE button) and interactive element 956 (CANCEL button). A user may save changes to parameters for a queue by, for example, clicking interactive element 954. A user may cancel changes to parameters for a queue by, for example, clicking interactive element 956. An identifier (for example, a numerical identifier) may be assigned to a new queue by the virtual receptionist system. As shown in FIG. 9A, example queue names may include RECEPTIONIST, CUSTOMER HAPPINESS, SUPPORT, or SUPERVISOR. A user interaction (for example, clicking, hovering, swiping) with a row of an existing queue may open display 950, which may include a window (for example, a pop-up window) or a panel enabling a user to edit parameters of the existing queue.

Display 950 may enable a user to input new or revised queue parameters, including role priority, reservation timeout, queue timeout, timeout priority, or queuing style. Using role priority, a numerical value may be set for each role to prioritize communications sessions to particular roles. In some embodiments, the higher the numerical value, the higher the priority. Multiple roles may have the same numerical value, meaning the multiple roles may be equally prioritized. For example, as shown in FIG. 9B, a RECEPTIONIST queue may have a RECEPTIONIST role as a higher priority with an arbitrary numerical value of eighty (80), and the RECEPTIONIST queue may have a CUSTOMER SERVICE role as a lower priority with an arbitrary numerical value of forty (40), which is less than eighty (80); and the RECEPTIONIST queue may have a SUPERVISOR role with a priority value of forty (40), which is less than the RECEPTIONIST role and equal to the CUSTOMER SERVICE role. Reservation timeout may include the number of seconds (for example, twelve (12) seconds) to wait for an agent to respond to an inbound communication before moving the inbound communication to another available agent. Queue timeout may include the number of seconds (for example, fifteen (15) seconds) to wait before a priority of a call is increased. Timeout priority may include how much to increase the priority when a queue timeout occurs. Queue style may determine what sound is played while a telephone call is in queue. For example, FIG. 9B shows the queue style is set to RING—RING UNTIL INITIAL CONTACT, wherein a ringing sound is played until initial contact with an agent.

### II. Customer Account Configuration

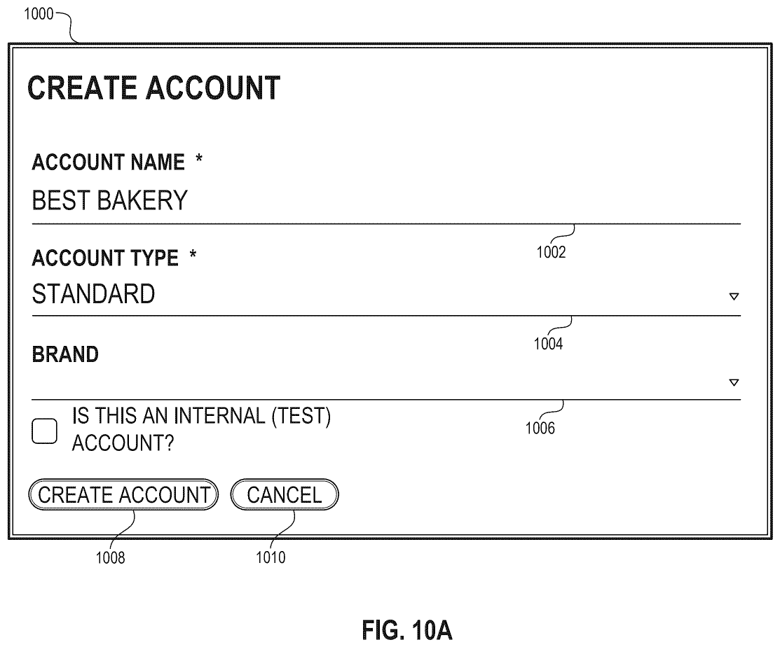

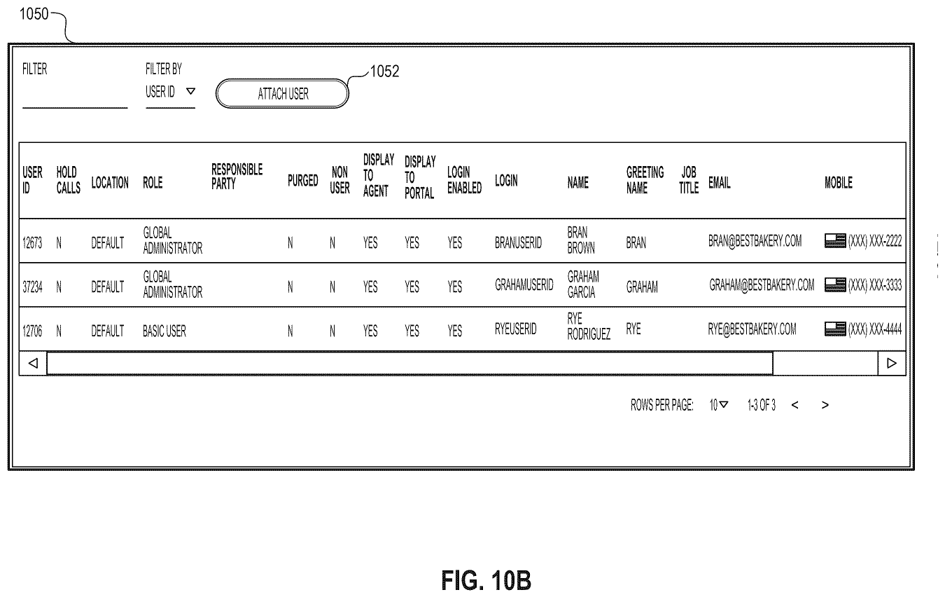

FIGS. 10A and 10B illustrate display 1000 and display 1050 of an example graphical user interface for creating or configuring an account of a customer of a virtual receptionist system, according to certain aspects of the present disclosure. Via an account configuration interface, the virtual reception system may enable a user (for example, an agent or a customer) to initialize a customer account and to configure various identifiers to associate with the customer account, such as one or more telephone numbers, fax numbers, physical addresses, or e-mail addresses. The account configuration interface may further enable a user to configure authorized users to associate with the customer account. For example, if a customer is a business entity, then authorized users may include one or more employees of the business entity. The account configuration interface may further enable a user to configure a knowledge base to associate with the customer account. The knowledge base may include information about services, pricing, hours of operation, answers to frequently asked questions, or other relevant details associated with the customer.

The account configuration interface may include display 1000 of FIG. 10A. A user interaction (for example, clicking, hovering, swiping) with an interactive element of the account configuration interface (for example, a CREATE ACCOUNT button) may open display 1000, which may include a window (for example, a pop-up window) or a panel enabling a user (for example, an agent or a customer) to input account creation parameters. Display 1000 may include a CREATE ACCOUNT form. The CREATE ACCOUNT form may include account name field 1002, account type field 1004, brand field 1006, create account button 1008, or cancel button 1010. Account name field 1002 may include a text field for inputting an account name (for example, Best Bakery), which may include an identifier or label used to represent a customer account within the virtual receptionist system. Account type field 1004 may include a drop-down menu including a list of third-party systems with which the virtual receptionist system may be partnered. The list may also include account type Legacy, for the legacy account type of the virtual receptionist system, and account type Standard, for a current or default account type of the virtual receptionist system. The virtual receptionist system may automatically assign certain attributes to the customer account based on the account type selected by a user. Brand field 1006 may include a drop-down menu including multiple brands of the virtual receptionist system. Functions of the virtual receptionist system may check for brand association to follow a proper behavior of a function. For example, each brand may have a unique logo, color scheme, product, add-on, billing behavior, or user interface design. The virtual receptionist system may automatically assign certain attributes to the customer account based on the brand selected by a user. Create account button 1008 may enable a user to submit the CREATE ACCOUNT form and to create a new account in the virtual receptionist system. Cancel button 1010 may enable a user to not submit the CREATE ACCOUNT form and to not create a new account in the virtual receptionist system.

The account configuration interface may include display 1050 of FIG. 10B. Display 1050 may include interactive element 1052 (ATTACH USER button). A user interaction (for example, clicking, hovering, swiping) with interactive element 1052 may open a window (for example, a pop-up window) or a panel enabling a user (for example, an agent or a customer) to input a full name, preferred greeting name, job title, email address, mobile telephone number, role, or other parameter for a new authorized user. An identifier (for example, a numerical identifier) may be assigned to a new authorized user by the virtual receptionist system. As shown in FIG. 10B, example authorized users of the customer account for Best Bakery may include Bran Brown, Graham Garcia, and Rye Rodriguez. As shown in FIG. 10B, example roles may include GLOBAL ADMINISTRATOR and BASIC USER. Authorized user privileges may be assigned according to a role. For example, as shown in FIG. 10B, a GLOBAL ADMINISTRATOR role may have higher access privileges than a BASIC USER role. For example, via the virtual receptionist platform, a global administrator may have access to transcripts generated from communications sessions of all authorized users of the customer account, and a basic user may have access to only transcripts generated from communications sessions of the basic user. A user interaction (for example, clicking, hovering, swiping) with a row of an existing authorized user may open a window (for example, a pop-up window) or a panel enabling a user to edit parameters of the existing authorized user.

In some embodiments, the account configuration interface may enable a user to create user groups, which may include one or more contacts or authorized users to whom communications should be routed or messages should be sent according to a communications session flow. In some embodiments, user groups may include one or more authorized users associated with a single authorized user. For example, under the Best Bakery account, Group Rye Rodriguez may include Rye Rodriguez and an administrative assistant of Rye Rodriguez. The user group may enable the virtual receptionist system to, for example, forward all messages left for Rye Rodriguez to some or all members of Group Rye Rodriguez or to forward all communications sessions relevant to Rye Rodriguez to a member of Group Rye Rodriguez. In some embodiments, custom user groups may be configured. For example, under account Best Bakery, Group Bread Production may include members of a bread production department and Group Delivery may include members of a delivery department.

In some embodiments, the account configuration interface may enable a user to create or configure a customer account that includes a primary customer account. A customer account may become a primary customer account when one or more additional customer accounts are linked to the customer account. The one or more additional customer accounts may become secondary customer accounts. For example, if customer accounts Best Breads and Best Pastries are linked to customer account Best Bakery, then customer accounts Best Breads and Best Pastries may become secondary customer accounts, and customer account Best Bakery may become a primary customer account. According to the hierarchical structure, usage data for a secondary customer account may be aggregated and attributed to a primary customer account for billing purposes, meaning, only the primary customer account receives an invoice. In some aspects of the embodiments, a secondary customer account may maintain an independent account configuration from the primary customer account, including, for example, identifiers (for example, telephone numbers, email addresses), settings, communications session flows, authorized user directories, or knowledge bases. In some embodiments, an authorized user attached to both a primary customer account and a secondary customer account may access both the primary customer account and the secondary customer account. In some embodiments, an authorized user attached to only a secondary customer account may access only the secondary customer account. In some embodiments, an authorized user attached to only a primary customer account may access only the primary account. In some embodiments, an authorized user attached to only a primary customer account may access both the primary account and the secondary account.

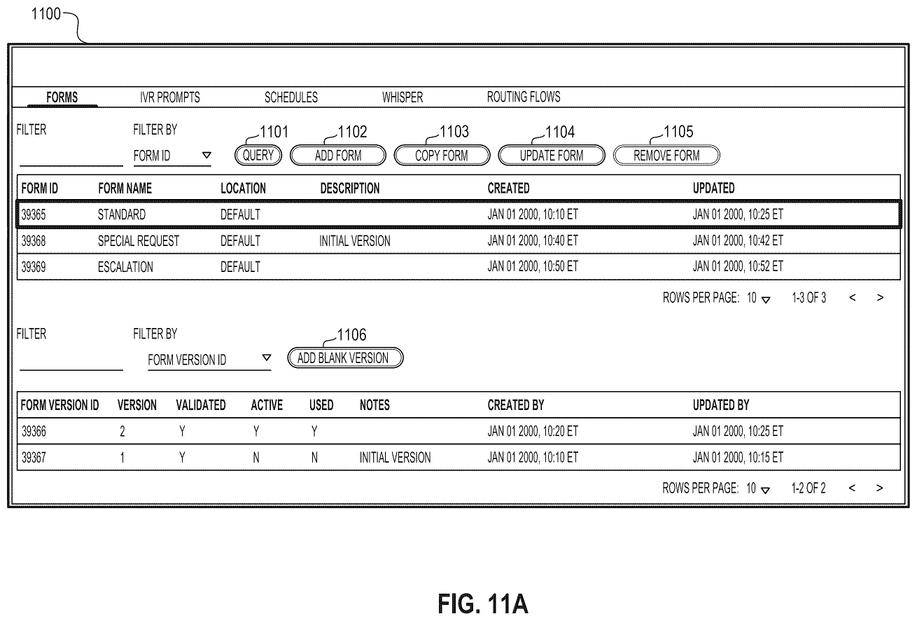

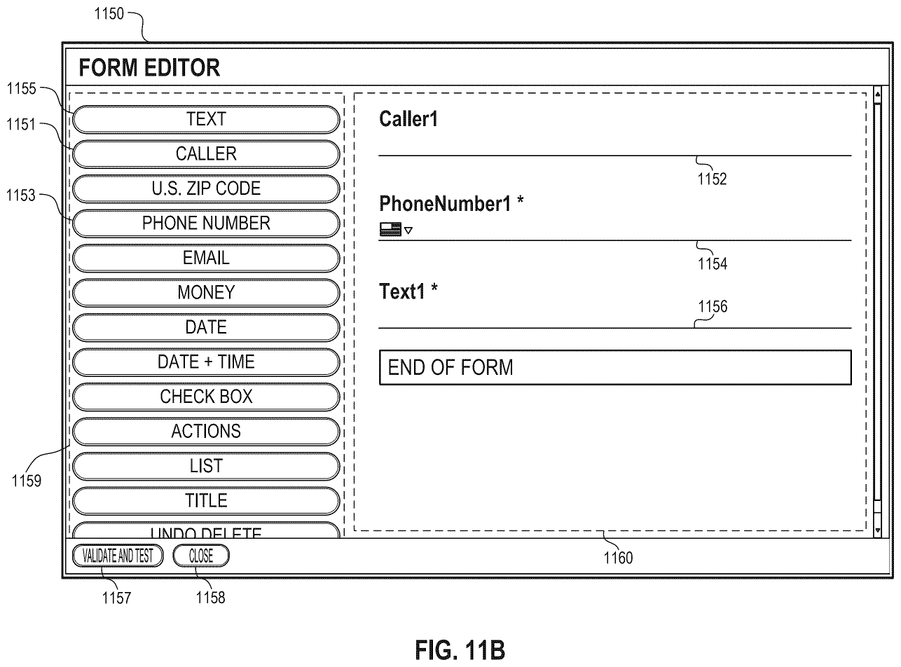

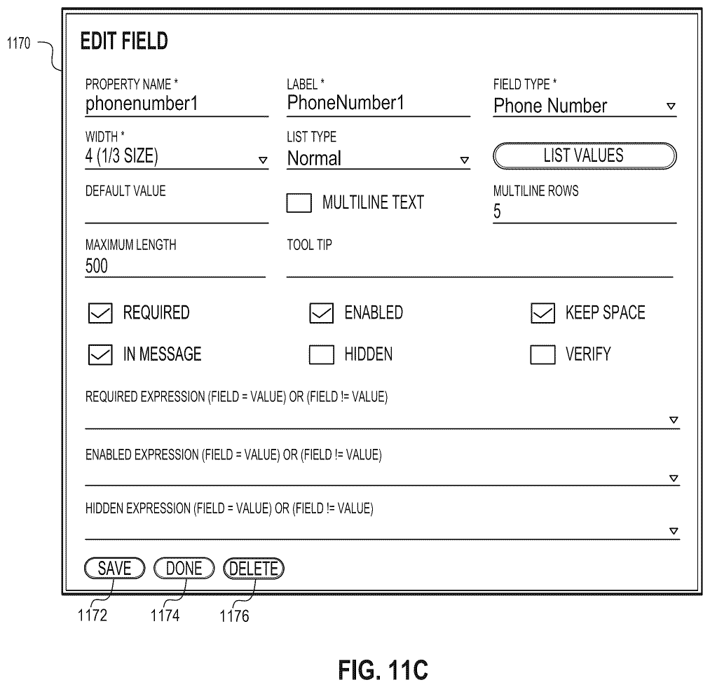

FIGS. 11A-11C illustrate display 1100, display 1150, and display 1170 of an example graphical user interface for generating interaction forms for a virtual receptionist system, according to certain aspects of the present disclosure. An interaction form may be displayed in a dashboard of an agent during a communications session with a client or customer. The agent may input data into the interaction form. By way of non-limiting examples, interaction forms may include intake forms, message taking forms, appointment booking forms, or customer relationship management (CRM) data entry forms.

As shown in FIG. 11A, an interaction form generation interface may include display 1100. Under a FORMS tab of the interaction form generation interface, display 1100 may include interactive element 1101 (QUERY button), interactive element 1102 (ADD FORM button), interactive element 1103 (COPY FORM button), interactive element 1104 (UPDATE FORM button), interactive element 1105 (REMOVE FORM button), or interactive element 1106 (ADD BLANK VERSION button). A user interaction (for example, clicking, hovering, swiping) with interactive element 1101 (QUERY button) may open a window (for example, a pop-up window) or a panel enabling a user (for example, an agent or a customer) to search for an existing interaction form stored in a database of the virtual receptionist system. A user interaction (for example, clicking, hovering, swiping) with interactive element 1103 (COPY FORM button) may enable a user (for example, an agent or a customer) to copy an existing interaction form to the current customer account or to another customer account. For example, as shown in FIG. 11A, example interaction form names may include STANDARD, SPECIAL REQUEST, and ESCALATION. A user may generate interaction form ESCALATION by selecting a row including interaction form SPECIAL REQUEST and by, for example, clicking interactive element 1103 (COPY FORM button) to open a window or a panel enabling a user to input, for example, name and location parameters for the new interaction form ESCALATION. A user interaction (for example, clicking, hovering, swiping) with interactive element 1104 (UPDATE FORM button) may open a window (for example, a pop-up window) or a panel enabling a user (for example, an agent or a customer) to modify an existing interaction form. A user interaction (for example, clicking, hovering, swiping) with interactive element 1105 (REMOVE FORM button) may open a window (for example, a pop-up window) or a panel enabling a user (for example, an agent or a customer) to remove an interaction form from the list of existing interaction forms. An identifier (for example, a numerical identifier) may be assigned to an interaction form or an interaction form version by the virtual receptionist system.

Display 1100 may include both a list of existing interaction forms and a list of versions of a selected interaction form. For example, as shown in FIG. 11A, selected interaction form STANDARD may include version one (1) and version two (2). A user interaction (for example, clicking, hovering, swiping) with interactive element 1106 (ADD BLANK VERSION button) may enable a user (for example, an agent or a customer) to add a blank version of an interaction form to the version list of a selected interaction form. A user interaction (for example, clicking, hovering, swiping) with a row including an interaction form version (for example, version 2 of the interaction form STANDARD) may open a window (for example, a pop-up window, such as a context menu) or a panel enabling a user (for example, an agent or a customer) to select an option to activate the selected version of the interaction form. Based on a user selection of an activate option, the virtual receptionist system may make the interaction form live, that is, the virtual receptionist system may deploy executable programming code associated with the interaction form such that the virtual receptionist system may begin displaying the interaction form in a dashboard of an agent during a communications session. In some embodiments, the virtual receptionist system may disable editing of a currently activated or previously activated version of an interaction form. In some aspects of the embodiments, a user may be prompted to copy the activated interaction form to a new version and to apply edits to the new version.

A user interaction (for example, clicking, hovering, swiping) with interactive element 1102 (ADD FORM button) may open display 1150, of FIG. 11B, which may include a window (for example, a pop-up window) or a panel enabling a user (for example, an agent or customer) to add, edit, or arrange fields to create an interaction form. Display 1150 may include a FORM EDITOR interface. The FORM EDITOR interface may include palette 1159 and canvas 1160. Palette 1159 may include multiple interactive elements associated with respective interaction form fields. For example, as shown in FIG. 11B, palette 1159 may include interactive element 1151 (CALLER button), interactive element 1153 (PHONE NUMBER button), and interactive element 1155 (TEXT button). In some embodiments, a user may add caller field 1152 to the canvas by, for example, clicking interactive element 1151 (CALLER button). A user may add telephone number field 1154 to the canvas by, for example, clicking interactive element 1153 (PHONE NUMBER button). A user may add text field 1156 to the canvas by, for example, clicking interactive element 1155 (TEXT button).

A user interaction (for example, clicking, hovering, swiping) with an interaction form field in canvas 1160 of FIG. 11B may open display 1170 of FIG. 11C, which may include a window (for example, a pop-up window) or a panel enabling a user (for example, an agent or customer) to configure the interaction form field. For example, double-clicking telephone number field 1154 may open display 1170. In an EDIT FIELD interface of display 1170, a user may configure parameters such as property name (for example, “phonenumber1”), field label (for example, “PhoneNumber1”), field type (for example, “Phone Number”), field width, or field default value. The EDIT FIELD interface of display 1170 may include SAVE button 1172, DONE button 1174, and DELETE button 1176. A user may save changes to parameters for an interaction form field by, for example, clicking SAVE button 1172. A user may close display 1170 by, for example, clicking DONE button 1174. A user may remove an interaction form field from canvas 1160 by, for example, clicking DELETE button 1176.

Display 1150 may include interactive element 1157 (VALIDATE AND TEST button) and interactive element 1158 (CLOSE button). A user interaction (for example, clicking, hovering, swiping) with interactive element 1157 may enable the virtual receptionist system to determine a validity of a functionality of an interaction form displayed in canvas 1160. The virtual receptionist system may determine the validity based on an operational configuration of the interaction form. Interaction form errors may include, for example, missing required fields, duplicate field names, or invalid input types. If the interaction form is validated, then the virtual receptionist system may generate executable programming code implementing the interaction form and, based on a user input, may deploy the interaction form by displaying the interaction form in a dashboard of an agent during a communications session. If the interaction form is invalidated, then the virtual receptionist system may display a notification of the invalidity of the functionality. The notification may include a color-coded pop-up window displaying a description of a cause of the invalidity. A user interaction (for example, clicking, hovering, swiping) with interactive element 1158 (CLOSE button) may enable a user to close display 1150.

### III. Communications Session Flow Development

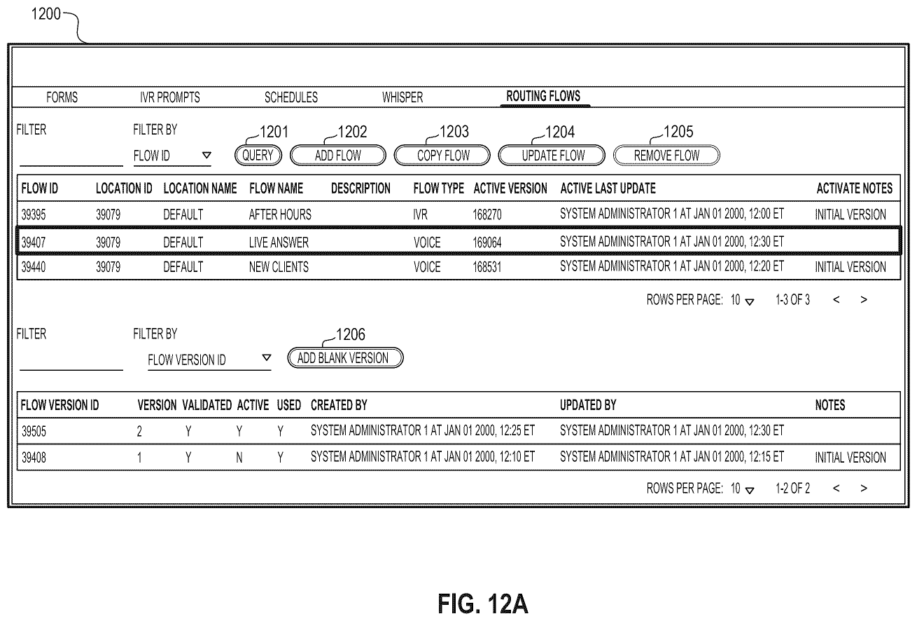

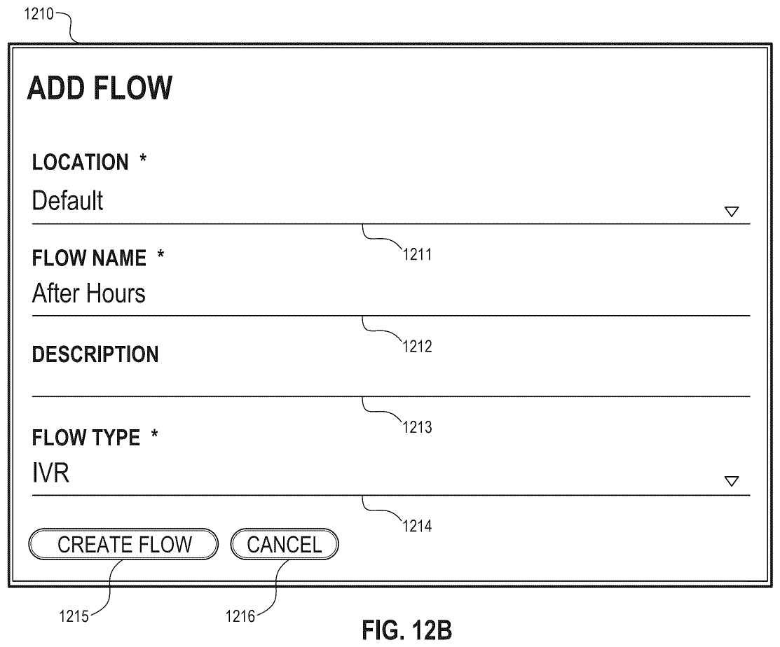

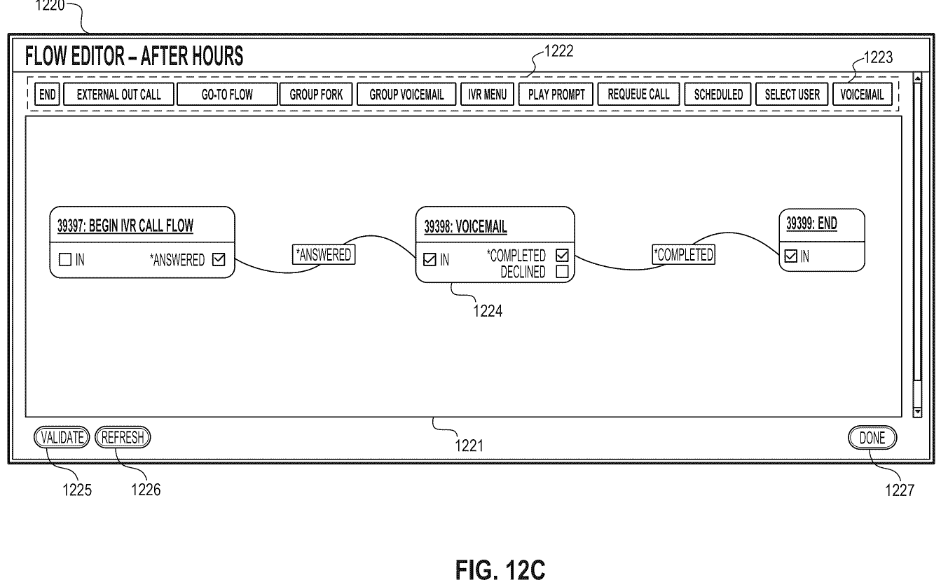

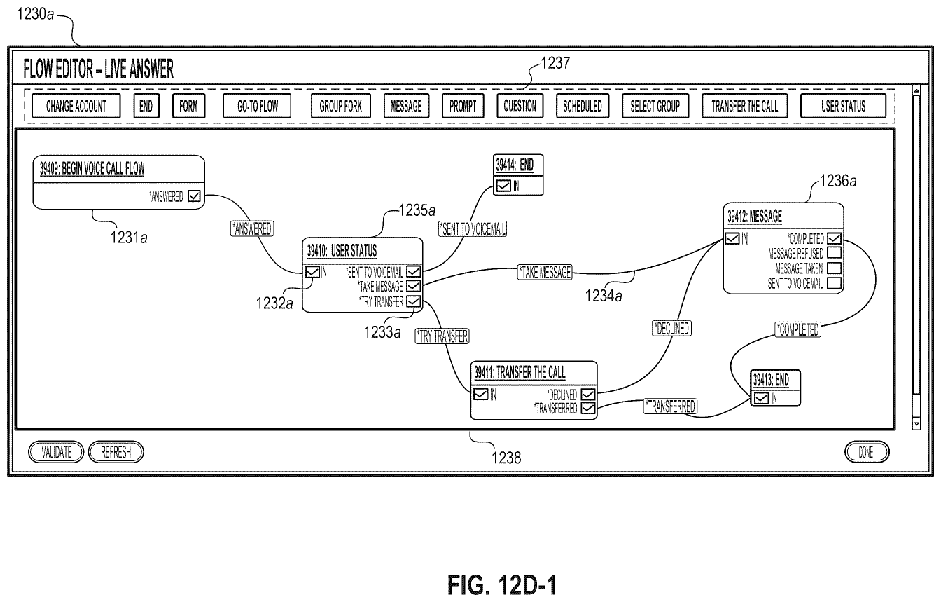

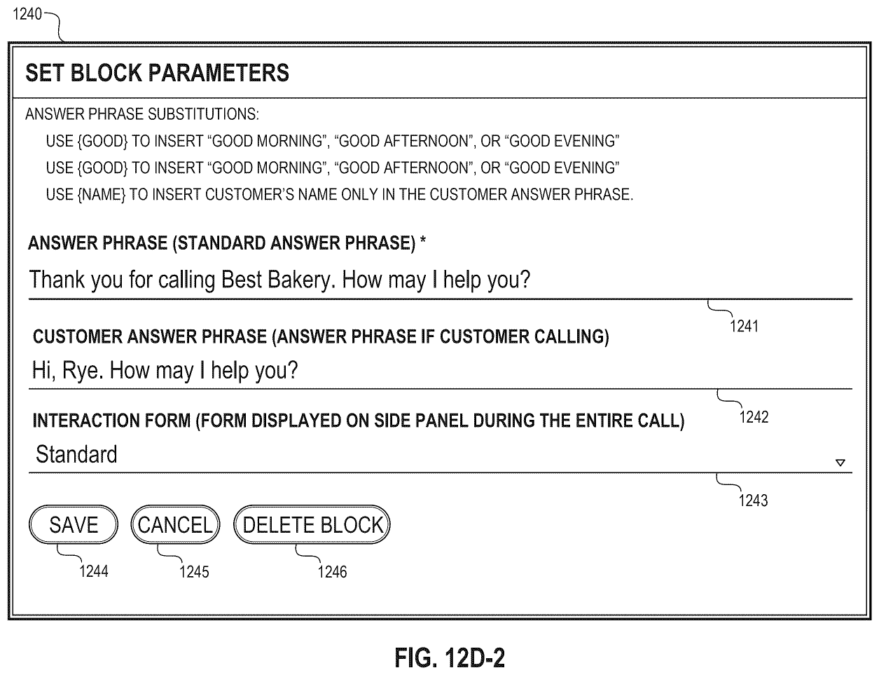

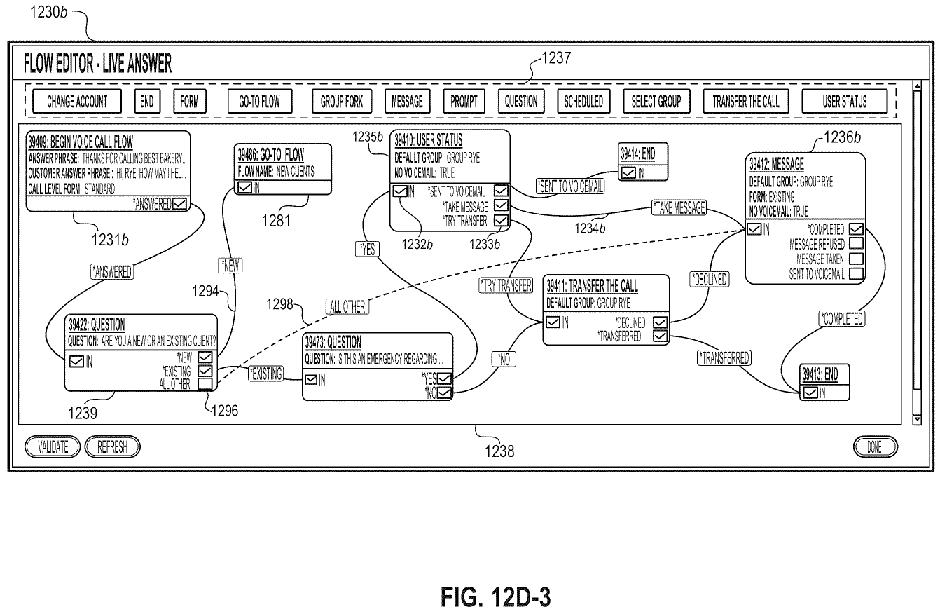

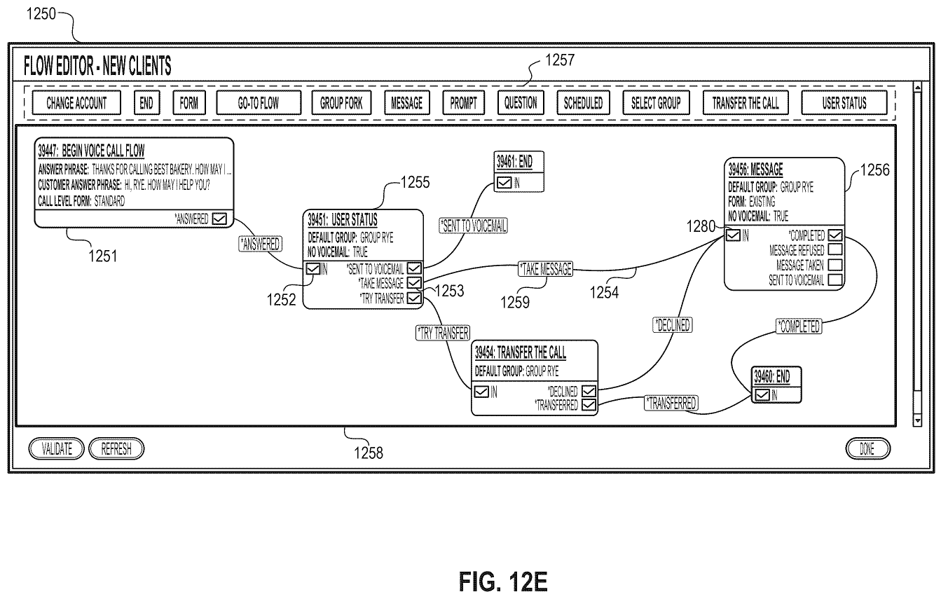

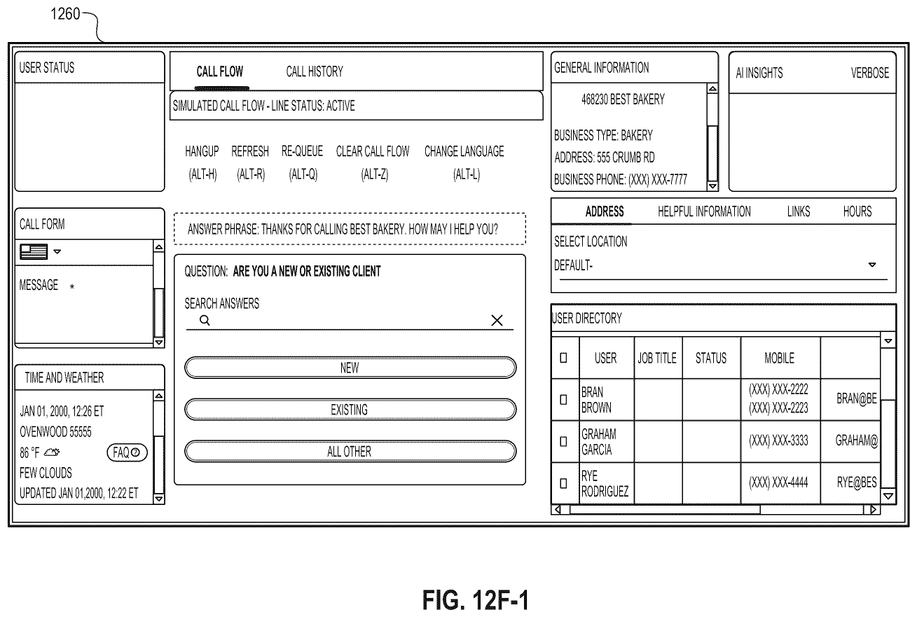

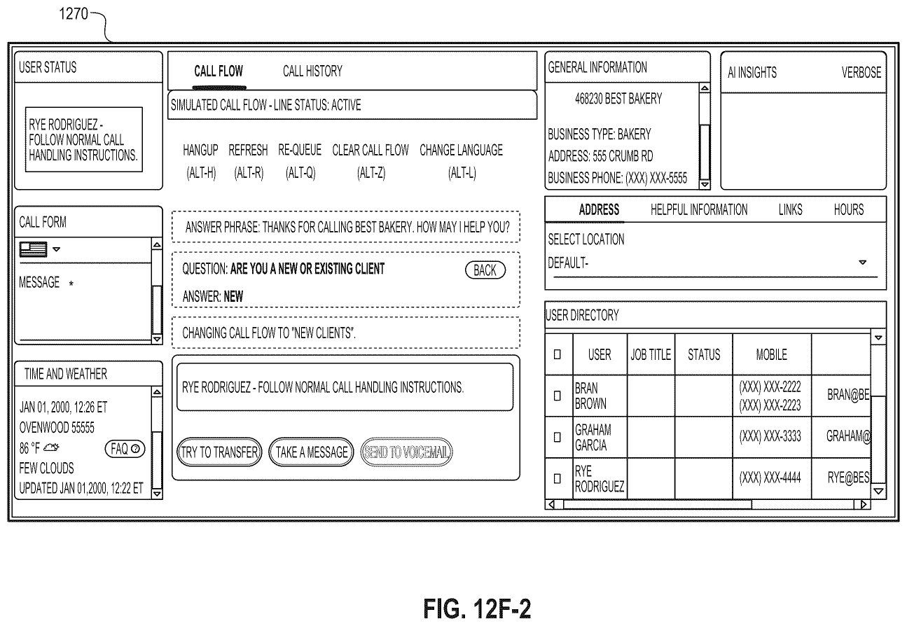

FIGS. 12A-12F illustrate display 1200, display 1210, display 1220, display 1230a, display 1230b, display 1240, display 1250, display 1260, and display 1270 of an example graphical user interface for developing communications session flows for a virtual receptionist system, according to certain aspects of the present disclosure. Display 1230a and display 1230b may be referred to collectively as “displays 1230.” The virtual receptionist system may generate executable programming code (for example, compiled or interpretable programming code) based on a communications session flow developed via a flow development interface (for example, a visual programming interface) of the virtual receptionist system. Once deployed by the virtual receptionist system, the executable programming code may cause the virtual receptionist system to route a communications session or to prompt an agent according to the functionality defined by the communications session flow. Although the examples used for the various embodiments of FIGS. 12A-12F disclosed herein may focus on voice-based or telephonic interactions, it should be readily apparent to those skilled in the art that the embodiments may extend to other forms of interaction. By way of non-limiting examples, the embodiments may extended to real-time or non-real-time communications across a wide range of communication channels, such as traditional telephony (for example, public switched telephone network (PSTN)), voice over Internet Protocol (VoIP), video conferencing, email, voicemail, live chat (for example, website support chat), text message (for example, short message service (SMS), multimedia message service (MMS)), social media messaging, and discussion forums, among others.

As shown in FIG. 12A, a flow development interface may include display 1200. Under a ROUTING FLOWS tab of a flow development interface, display 1200 may include interactive element 1201 (QUERY button), interactive element 1202 (ADD FLOW button), interactive element 1203 (COPY FLOW button), interactive element 1204 (UPDATE FLOW button), interactive element 1205 (REMOVE FLOW button), or interactive element 1206 (ADD BLANK VERSION button). A user interaction (for example, clicking, hovering, swiping) with interactive element 1201 (QUERY button) may open a window (for example, a pop-up window) or a panel enabling a user (for example, an agent or a customer) to search for an existing communications session flow stored in a database of the virtual receptionist system. A user interaction (for example, clicking, hovering, swiping) with interactive element 1203 (COPY FLOW button) may open a window (for example, a pop-up window) or a panel enabling a user (for example, an agent or a customer) to copy an existing communications session flow to the current customer account or to another customer account. For example, as shown in FIG. 12A, example communications session flow names may include AFTER HOURS, LIVE ANSWER, and NEW CLIENTS. A user may generate flow NEW CLIENTS by selecting a row including flow LIVE ANSWER and by, for example, clicking interactive element 1203 (COPY FLOW button) to open a window or a panel enabling a user to input, for example, name and location parameters for the new flow NEW CLIENTS. A user interaction (for example, clicking, hovering, swiping) with interactive element 1204 (UPDATE FLOW button) may open a window (for example, a pop-up window) or a panel enabling a user (for example, an agent or a customer) to modify an existing communications session flow. A user interaction (for example, clicking, hovering, swiping) with interactive element 1205 (REMOVE FLOW button) may open a window (for example, a pop-up window) or a panel enabling a user (for example, an agent or a customer) to remove a communications session flow from the list of existing communications session flows. An identifier (for example, a numerical identifier) may be assigned to a communications session flow or a communications session flow version by the virtual receptionist system.

Display 1200 may include both a list of existing communications session flows and a list of versions of a selected communications session flow. For example, as shown in FIG. 12A, selected communications session flow LIVE ANSWER may include version one (1) and version two (2). A user interaction (for example, clicking, hovering, swiping) with interactive element 1206 (ADD BLANK VERSION button) may enable a user (for example, an agent or a customer) to add a blank version of a communications session flow to the version list of a selected communications session flow. A user interaction (for example, clicking, hovering, swiping) with a row including a communications session flow version (for example, version two (2) of flow LIVE ANSWER) may open a window (for example, a pop-up window) or a panel enabling a user (for example, an agent or a customer) to select an option to activate the selected version of the communications session flow. Based on a user selection of an activate option, the virtual receptionist system may make the communications session flow live, that is, the virtual receptionist system may deploy executable programming code associated with the communications session flow such that the virtual receptionist system may begin handling communications sessions according to the executable programming code. In some embodiments, the virtual receptionist system may disable editing of a currently activated or previously activated version of a communications session flow. In some aspects of the embodiments, a user may be prompted to copy the activated communications session flow to a new version and to apply edits to the new version.

As shown in FIG. 12B, a flow development interface may include display 1210. A user interaction (for example, clicking, hovering, swiping) with interactive element 1202 (ADD FLOW button) of display 1200 (FIG. 12A) may open display 1210, which may include a window (for example, a pop-up window) or a panel enabling a user (for example, an agent or a customer) to input flow creation parameters. Display 1210 may include an ADD FLOW form. The ADD FLOW form may include location field 1211, flow name field 1212, description field 1213, flow type field 1214, create flow button 1215, or cancel button 1216. Location field 1211 may include a drop-down menu including options for locations for the communications session flow. Flow name field 1212 may include a text field for inputting a flow name (for example, After Hours), which may include an identifier or label used to represent a communications session flow within the virtual receptionist system. Description field 1213 may include a text field for inputting a description of a communications session flow. Flow type field 1214 may include a drop-down menu including options for communications session flow types. By way of non-limiting examples, communications session flow types may include voice (for example, telephonic), interactive voice response (IVR), text message (for example, SMS or MMS), e-mail, or custom. For example, as shown in FIG. 12A, flow AFTER HOURS includes flow type IVR, and flows LIVE ANSWER and NEW CLIENTS include flow type VOICE. Create flow button 1215 may enable a user to submit the ADD FLOW form and to create a new communications session flow in the virtual receptionist system. A user interaction (for example, clicking, swiping, hovering) with create flow button 1215 may open a display (for example, display 1220), which may include a window (for example, a pop-up window) or a panel enabling a user (for example, an agent or a customer) to edit the communications session flow. Based on the input of flow type field 1214, a corresponding communications session flow template may be added to a canvas (for example, canvas 1221 of FIG. 12C) of the display for editing the communications session flow. The template may include blank or pre-populated flow parameters (for example, greeting phrase upon initial contact of an agent with a client or customer). In some embodiments, the pre-populated parameters may be based on customer account data. In some embodiments, if flow type field 1214 includes a selection of a custom communications session flow type, then the canvas may not include a communications session flow template and the canvas may be blank. Cancel button 1216 may enable a user to not submit the ADD FLOW form and to not create a new communications session flow in the virtual receptionist system.

FIG. 12C illustrates display 1220 of an example graphical user interface for developing flow AFTER HOURS of FIG. 12A. Display 1220 may include a FLOW EDITOR interface. The FLOW EDITOR interface may include canvas 1221, palette 1222, interactive element 1225 (VALIDATE button), interactive element 1226 (REFRESH button), and interactive element 1227 (DONE button). Palette 1222 may include VOICEMAIL label 1223. Canvas 1221 may display flow AFTER HOURS, which may include VOICEMAIL block 1224. Canvas 1221 may include a workspace where a user may build a communications session flow. A communications session flow may include multiple graphical blocks (or nodes) connected by one or more links. The graphical blocks and the one or more links may represent predefined programming elements. By way of non-limiting examples, graphical blocks or links may represent data sources or events; destinations for data; processing or transforming of data; or logic or routing of data. Palette 1222 may include a plurality of labels (for example, VOICEMAIL label 1223) associated with one or more graphical blocks. In some embodiments, a label may include a lightweight visual representation of one or more graphical blocks. A user may add a graphical block to canvas 1221 by, for example, dragging a label (for example, VOICEMAIL label 1223) to a location on canvas 1221. Based on the final location indicated by the user, a graphical block associated with the block label (for example, VOICEMAIL block 1224, associated with VOICEMAIL label 1223) may be added at or near the final location on canvas 1221. For example, a user may click and begin dragging a label (for example, VOICEMAIL label 1223). In some embodiments, a drag preview or “ghost image” of the label may be created as the label is dragged onto the canvas (for example, canvas 1221). As a user drags a label (or label drag preview) over the canvas, the system may show drop targets or highlight valid or recommended positions for a graphical block associated with the label. When the user drops the label (for example, by unclicking the label), a new graphical block associated with the label (for example, a new VOICEMAIL block, such as VOICEMAIL block 1224, associated with VOICEMAIL label 1223) may be instantiated and the new graphical block may be placed at or near the position on the canvas.

Labels, and corresponding graphical block options, available in palette 1222 may correspond to a communications session flow type. In some embodiments, a communications session flow type may be selected via a flow type field of a flow creation form (for example, flow type field 1214 of the ADD FLOW form of display 1210 (FIG. 12B)). For example, the labels, and the corresponding graphical block options, of a palette for an IVR flow type (for example, palette 1222 (FIG. 12C)) may differ from the labels, and the corresponding graphical block options, of a palette for a voice (or telephonic) flow type (for example, palette 1237 (FIG. 12D-1)). Example graphical blocks may include the following:

Begin block: may represent routing logic triggered by the virtual receptionist system receiving an inbound communication associated with a customer profile stored by a database of the virtual receptionist system. The routing logic may define whether the inbound communication is directed to first contact with an automated system of the virtual receptionist system (for example, an IVR system) or to a human agent of the virtual receptionist system. A Begin block may be included by default in communications session flow templates for IVR flow types and for voice flow types. In some embodiments, a Begin block may be added by default to a communications session flow for a custom flow type. In some embodiments, a palette (for example, palette 1222) may not include a Begin block.

Change Account block: may enable an agent to connect multiple accounts. For example, a large customer may have multiple accounts and clients of the customer may use an incorrect telephone number when attempting to reach the customer. The Change Account block may allow such clients to be automatically redirected to the correct account without the requirement of manually transferring such customers to the correct telephone number or requiring the customer to hang up and redial.

End block: may terminate the communications session. For example, a communications session may be terminated when the virtual receptionist system disables a connection between a client device and the system.

Evaluate Score block: may be used in conjunction with one or more Scoring Question blocks to evaluate the progression of a communications session. For example, if a client or customer answers a number of questions with answers that have unique values, then the summation of the unique values may be evaluated to determine which path to direct the communications session. This may remove the decision making from an agent.

Form block: may be used to compile predefined fields for an agent to gather information that may be copied to a final Message block.

Go-To Flow block: may enable multiple communications session flows to be connected within an account. Multiple communications session flows may be created and then linked together to scale up account complexity.

Group Fork block: may be used in conjunction with a Select Group block and may provide the ability to deviate from a communications session flow defined by the Select Group block. For example, multiple users may follow the same communications session flow, and the Select Group block may determine which User's Status/Transfer Node/Message is set as the default. The Group Fork block may allow for any number of users to deviate from the communications session flow when selected.

Group Voicemail block: may enable the transfer of a call to a shared voicemail box.

Message block: may include information to gather from or deliver to one or more users or user groups.

Prompt block: may include text to display to an agent. The text may include a reminder or an instruction for the agent.

Question block: may include a question with a list of answers that branches the communications session flow into multiple custom paths.

Scheduled block: may enable time-of-day routing. A schedule of available hours of the customer may be maintained by the block and, depending on when a call arrives, the communications session flow may be routed to one of two available paths. For example, inside of available hours, a call may be directed to a Transfer the Call block. Outside of available hours, the call may be diverted from a Transfer the Call block and the call may be directed to voicemail or to a customizable action.

Scoring Question block: may be used in conjunction with an Evaluate Score block. The Scoring Question block may be similar to the Question block. The answers of the Scoring Question block may be assigned a numerical score used for weighting.

Select Group block: may define which user status, transfer node, or message is set as a default, enabling a fewer number of communications session flows to accommodate users.

Transfer the Call block: may provide a telephone widget with a pre-programmed telephone number set to a user for ease of transfer by an agent.

User Status block: may provide a current application or portal status as set by a user. For example, a user may set a custom status, such as “I am in court and will return calls on the next business day,” or a user may select predefined statuses, such as “Taking Calls,” “Away,” or “Follow Normal Call Handling.”

A user interaction (for example, clicking, hovering, swiping) with interactive element 1225 (VALIDATE button) may enable the virtual receptionist system to determine a validity of a communications session flow. The virtual receptionist system may determine the validity based on an operational configuration of the graphical blocks or links included in the communications session flow. In some embodiments, the virtual receptionist system may determine a validity of an operational configuration of a subset of the graphical blocks or links included in the communications session flow. In some aspects of the embodiments, a user may select the subset of the graphical blocks or links by highlighting the graphical block or links. Communications session flow errors may include, for example, missing graphic block parameters, unlinked graphical blocks, or operation errors. If the communications session flow is validated, then the virtual receptionist system may generate executable programming code implementing the functionality of the communications session flow and may deploy the executable programming code via the virtual receptionist system. If the communications session flow is invalidated, then the virtual receptionist system may display a notification of the invalidity of the functionality. The notification may include a color-coded pop-up window displaying a description of a cause of the invalidity. A user interaction (for example, clicking, hovering, swiping) with interactive element 1226 (REFRESH button) may enable a user to reload or update an operational configuration or a spatial configuration of a communications session flow displayed on canvas 1221. For a first example, based on a user interaction with interactive element 1226 (REFRESH button), the virtual receptionist system may fetch the most recent updates to the communications session flow from a backend or database to reload or update an operational configuration of the communications session flow, ensuring edits made by one or more users or updates to a customer account are reflected in the communications session flow. For a second example, a spatial configuration of the graphical blocks or links of a communications session flow may become cluttered or misaligned due to editing. Based on a user interaction with interactive element 1226 (REFRESH button), the virtual receptionist system may revise the spatial configuration to a default or recommended configuration. A user interaction (for example, clicking, hovering, swiping) with interactive element 1227 (DONE button) may enable a user to close display 1220.

In some embodiments, a validity of a functionality of a communications session flow may be determined via a main display of a flow development interface, such as display 1200 of FIG. 12A. A user interaction (for example, clicking, hovering, swiping) with a row including a communications session flow version (for example, version two (2) of flow LIVE ANSWER, as shown in FIG. 12A) may open a window (for example, a pop-up window, such as a context menu) or a panel enabling a user (for example, an agent or a customer) to select an option to validate the selected version of the communications session flow. Based on a user selection of a validate option, the virtual receptionist system may determine the validity based on an operational configuration of the graphical blocks or links included in the communications session flow. If the communications session flow is validated, then the virtual receptionist system may generate executable programming code implementing the functionality of the communications session flow and may deploy the executable programming code via the virtual receptionist system. If the communications session flow is invalidated, then the virtual receptionist system may display a notification of the invalidity of the functionality. The notification may include a color-coded pop-up window displaying a description of a cause of the invalidity.

FIG. 12D-1, FIG. 12D-2, and FIG. 12D-3 illustrate display 1230a, display 1240, and display 1230b, respectively, of an example graphical user interface for developing flow LIVE ANSWER of FIG. 12A. As shown in FIG. 12D-1, display 1230a may include a FLOW EDITOR interface. The FLOW EDITOR interface may include palette 1237 and canvas 1238. Canvas 1238 may display a communications session flow template for a voice flow type. The template may correspond to a user input in a flow type field of an add flow form (for example, flow type field 1214 of the ADD FLOW form of display 1210 (FIG. 12B)). A user interaction (for example, clicking, swiping, hovering) with a create flow button (for example, create flow button 1215 (FIG. 12B)) may open display 1230a, which may include a window (for example, a pop-up window) or a panel enabling a user (for example, an agent or a customer) to edit flow LIVE ANSWER. Based on the input of the flow type field, the voice flow type template may be automatically added to canvas 1238. As shown in FIG. 12D-1, the voice flow type template may include default BEGIN block 1231a, default TAKE MESSAGE link 1234a, default USER STATUS block 1235a, and default MESSAGE block 1236a. Default USER STATUS block 1235a may include default IN port 1232a, which may include an input port, and default TRY TRANSFER port 1233a, which may include an output port.

A user interaction (for example, clicking, hovering, swiping) with a graphical block in a canvas may open a display that may include a window (for example, a pop-up window) or a panel enabling a user (for example, an agent or customer) to configure parameters of a graphical block. For example, a user interaction (for example, clicking, hovering, swiping) with default BEGIN block 1231a in canvas 1238 may open display 1240, of FIG. 12D-2, which may include a window (for example, a pop-up window) or a panel enabling a user (for example, an agent or customer) to configure parameters of default BEGIN block 1231a.

As shown in FIG. 12D-2, display 1240 may include a SET BLOCK PARAMETERS form. The SET BLOCK PARAMETERS form may include answer phrase field 1241, customer answer phrase field 1242, interaction form field 1243, interactive element 1244 (SAVE button), interactive element 1245 (CANCEL button), and interactive element 1246 (DELETE BLOCK button). Answer phrase field 1241 may include a text field for inputting an answer phrase to be displayed as a prompt for an agent in a dashboard of the agent during a communications session executed according to the communications session flow. The prompt may include a phrase with which an agent should greet a client of a customer upon initial contact with the client (for example, “Thank you for calling Best Bakery. How may I help you?”). Customer answer phrase field 1242 may include a text field for inputting an answer phrase to be displayed as a prompt for an agent in a dashboard of the agent during a communications session executed according to the communications session flow. The prompt may include a phrase with which an agent should greet a customer upon initial contact with the customer (for example, “Hi, Rye. How may I help you?”, wherein Rye may be a contact or an authorized user associated with customer account Best Bakery). Interaction form field 1243 may include a drop-down menu including one or more options for interaction forms associated with a customer account (for example, interaction form Standard). An interaction form may include a form that may be displayed to an agent during a communications session. In some embodiments, a default graphical block of a template (for example, a voice type template) may include prepopulated fields. In some aspects of the embodiments, the prepopulated fields may include suggested inputs determined by the virtual receptionist system (for example, using one or more artificial intelligence (AI) models). In some aspects of the embodiments, the prepopulated fields may include data associated with an account of a customer. For example, an account of customer Best Bakery may list a preferred or a required answer phrase for clients of Best Bakery as, “It is a beautiful day at Best Bakery! How may we serve you?” The preferred or required answer phrase may be prepopulated in an answer phrase field of a default begin block (for example, answer phrase field 1241 of default BEGIN block 1231a). A user may save changes to parameters for a graphical block by, for example, clicking interactive element 1244 (SAVE button). A user may cancel changes to parameters for a graphical block by, for example, clicking interactive element 1245 (CANCEL button). A user may remove a graphical block from a canvas by, for example, clicking interactive element 1246 (DELETE BLOCK button).

As shown in FIG. 12D-3, display 1230b may include a FLOW EDITOR interface. The FLOW EDITOR interface may include palette 1237 and canvas 1238. Canvas 1238 may include modifications to flow LIVE ANSWER, for example, modifications made to the BEGIN block in FIG. 12D-2. As shown in FIG. 12D-3, flow LIVE ANSWER may be edited to include modified BEGIN block 1231b, modified TAKE MESSAGE link 1234b, modified USER STATUS block 1235b, and modified MESSAGE block 1236b. Modified USER STATUS block 1235b may include modified IN port 1232b, which may include an input port, and modified TRY TRANSFER port 1233b, which may include an output port. Flow LIVE ANSWER may be edited to include additional blocks, such as QUESTION block 1239 and GO-TO FLOW block 1281. GO-TO FLOW block 1281 may link flow LIVE ANSWER to flow NEW CLIENTS, listed in FIG. 12A and illustrated in FIG. 12E. Go-To blocks may enable communications session flows of an account to be connected, which may efficiently scale up communications session flow complexity.

As shown, for example, by default BEGIN block 1231a and modified BEGIN block 1231b (collectively referred to as BEGIN block 1231), an appearance of a graphical block may be modified in response to a change to a parameter of a graphical block or to indicate a change to a parameter of a graphical block. For example, an appearance of BEGIN block 1231 of flow LIVE ANSWER may be updated from the appearance of default BEGIN block 1231a to the appearance of modified BEGIN block 1231b to indicate a configuration of the parameters of BEGIN block 1231 (for example, as shown in FIG. 12D-2).

As shown in FIG. 12E, display 1250 may include a FLOW EDITOR interface. The FLOW EDITOR interface may include palette 1257 and canvas 1258. A user interaction (for example, clicking, swiping, hovering) with an interactive element (for example, interactive element 1204 (UPDATE FLOW button)) or a user interaction (for example, clicking, hovering, swiping) with a row including a communications session flow version (for example, version two (2) of flow LIVE ANSWER) may open a window (for example, a pop-up window) or a panel enabling a user (for example, an agent or a customer) to edit an existing flow. For example, a user interaction (for example, clicking, hovering, swiping) with a row including a flow version for flow NEW CLIENTS may open display 1250, enabling a user (for example, an agent or a customer) to edit flow NEW CLIENTS. As shown in FIG. 12E, flow NEW CLIENTS may include BEGIN block 1251, TAKE MESSAGE link 1254, TAKE MESSAGE link label 1259, USER STATUS block 1255, and MESSAGE block 1256. USER STATUS block 1235 may include IN port 1252, which may include an input port, and TAKE MESSAGE port 1253, which may include an output port. MESSAGE block 1256 may include IN port 1280, which may include an input port.

Graphical blocks may be associated by one or more links. A link may connect a pair of graphical blocks by an output port of a first graphical block and an input port of a second graphical block. A directional dependency of the pairs of graphical blocks may be indicated by a text label of a link. A text label may indicate a signal associated with an output port of a graphical block. For example, as shown in FIG. 12E, TAKE MESSAGE link label 1259 of TAKE MESSAGE link 1254 may indicate a signal from TAKE MESSAGE port 1253, an output port of USER STATUS block 1255, to IN port 1280, an input port of MESSAGE block 1256.

In some embodiments, configuring a parameter of a graphical block may add or remove a port of the graphical block or may modify a label of a port of the graphical block. For example, for a QUESTION block (for example, QUESTION block 1239 of FIG. 12D-3), a user may configure a phrase to be displayed as a prompt for an agent in a dashboard of the agent during a communications session executed according to a communications session flow. The prompt may include a question that the agent should ask a client of a customer. For example, the question may include, “Are you a new or an existing client?” A user may also configure at least two answer options with which a client may reply. For example, the answer options may include yes or no. Before configuring the question and answer parameters of the QUESTION block, the QUESTION block may not include a preview of the question, and the QUESTION block may include a first port labeled ANSWER 001 and a second port labeled ANSWER 002. After configuring the question and answer parameters, the first port may be updated to be labeled YES, and the second port may be updated to be labeled NO, as shown in FIG. 12D-3. A third port, labeled ALL OTHER, may be added to the QUESTION block to account for client answers that do not include yes or no, as shown in FIG. 12D-3. An indicator, such as an asterisk (for example, as shown in FIG. 12D-3, the asterisk preceding the NEW port label) may indicate a required output port, that is, an output port that must be configured or enabled. An optional output port, such as ALL OTHER output port 1296, may not include the indicator, which may indicate the output port may be configured or unconfigured, or may be enabled or disabled.

An indicator, such as a checkmark, may indicate whether a port is enabled. A user may link a first graphical block to a second graphical block by linking an input port of the first graphical block to an output port of the second graphical block, or by linking an output port of the first graphical block to an input port of the second graphical block. Upon a user linking a first graphical block to a second graphical block, a checkmark may appear in each port, indicating the ports are enabled and the link between the graphical blocks is active. If a port is enabled and a link between the graphical blocks is active, then the link between the graphical blocks may be included in the operational configuration of the communications session flow. A checkmark may be removed (for example, based on a user input) from the input port or the output port, indicating the port is disabled and the link between the graphical blocks is inactive. In some embodiments, the link may remain between the graphical blocks when the link is active or inactive, which may allow a user to enable or disable part of the communications session flow (for example, during debugging or experimentation) without losing the structure or connections of the communications session flow. In some embodiments, an active link and an inactive link may be displayed using different line types. For example, as shown in FIG. 12D-3, an active link, such as active NEW link 1294 may be displayed as a solid line, and inactive ALL OTHER link 1298 may be displayed as a dashed line. If a port is disabled and a link between the graphical blocks is inactive, then the link between the graphical blocks may be excluded from the operational configuration of the communications session flow. In some embodiments, a user may remove a link by completing an appropriate interaction with the user interface. For example, a user may double-click a link; a user may right-click a link, which may open a context menu with selectable options such as “Delete” or “Disconnect”; a user may click and drag a link away from a corresponding port or into an open space of the canvas; or a user may delete a graphical block, which may cause all links connected to the graphical block to be removed.

FIGS. 12F-1 and 12F-2 illustrate display 1260 and 1270 of an example graphical user interface for simulating a communications session flow. For example, as shown in FIG. 12F-1 and FIG. 12F-2, flow LIVE ANSWER (see FIG. 12D-3) may be simulated. According to the simulation, an inbound telephone call from a client of a customer may be directed to a human agent because of the communications session flow type of flow LIVE ANSWER, the flow type including a voice-based flow type. As shown in FIG. 12F-1, the human agent may answer the call with the answer phrase configured for BEGIN block 1231 of flow LIVE ANSWER in FIG. 12D-2: “Thanks for calling Best Bakery. How may I help you?” Flow LIVE ANSWER may proceed to QUESTION block 1239, which may prompt the human agent to ask the client, “Are you a new or an existing client?” The simulator may provide the human agent with answer buttons associated with parameters configured for QUESTION block 1239, the answer options including new, existing, or all others. The client may reply that they are a new client. The human agent may select the NEW button. As shown in FIG. 12F-2, flow LIVE ANSWER may proceed to GO-TO FLOW block 1281, which may connect flow LIVE ANSWER to flow NEW CLIENTS. Flow NEW CLIENTS may proceed to USER STATUS block 1255 and may prompt the human agent with three options based on the parameters of USER STATUS block 1255, the three options including try to transfer the telephone call to Group Rye, take a message, or send the telephone call to voicemail.

### IV. AI-Assisted Communications Session Handling

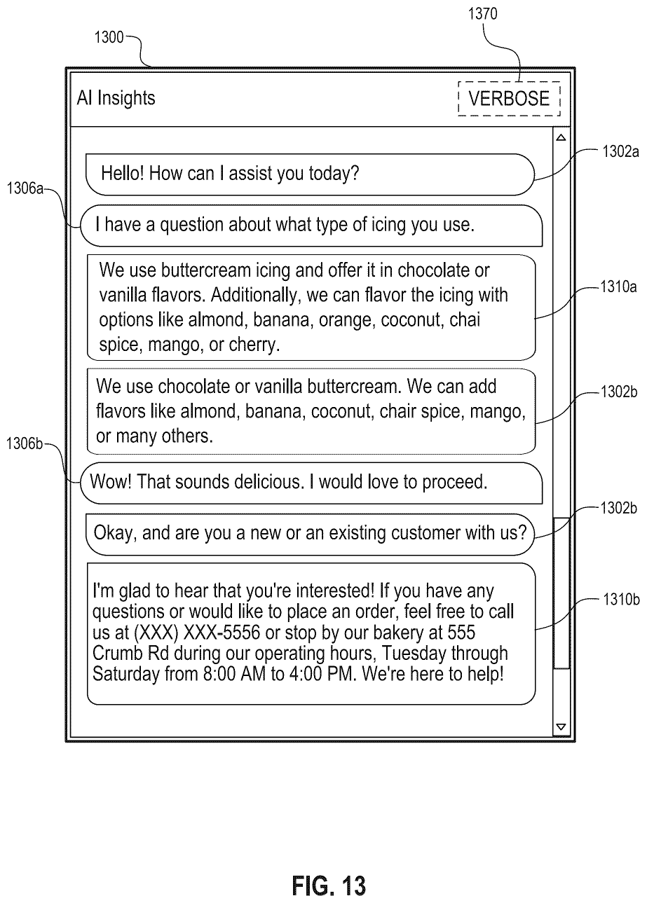

FIG. 13 illustrates an example artificial intelligence (AI) insights panel 1300 of a dashboard of a graphical user interface of a virtual receptionist system, according to certain aspects of the present disclosure. The dashboard may include a dashboard of an agent, and AI insights panel 1300 may display suggested responses to user queries (for example, client queries or customer queries).

In some embodiments, the first contact for a communications session (for example, telephone call, text message, email, or the like) may be an automated agent, for example, an interactive voice response (IVR) system or a conversational user interface (UI). The conversational UI may leverage AI technologies to understand or respond to user queries. A second contact for the communications session may be a human agent. For example, if an automated agent fails to answer a user query, then the communications session may be transferred to a queue of a human agent. Via an AI insights panel of a dashboard of the human agent, the human agent may be provided a transcript of the interaction between a user (for example, a new or existing client of a customer) and the automated agent. Upon receiving an acceptance from the human agent, a connection may be established between the user and the human agent. Via the dashboard, the human agent may be provided with suggested responses to provide to the user. During the interaction between the user and the human agent, the transcript may be updated with suggested responses (for example, suggested response 1310a and suggested response 1310b). In some embodiments, the transcript may be updated with suggested responses and with at least one of the queries of the user (for example, user query 1306a and user query 1306b) and the actual responses of the human agent (for example, actual response 1302a and actual response 1302b). In some embodiments, a human agent may toggle transcript button 1370 between Verbose and Bot-Only. In Verbose mode, the transcript may include user queries, suggested responses, and actual responses. In Bot-Only mode, the transcript may include only suggested responses.

In some embodiments, contextually relevant responses may be generated based on a knowledge base of a customer. For example, the knowledge base may include information about services, pricing, hours of operation, answers to frequently asked questions, or other relevant details associated with the customer. The knowledge base may be stored under an account of the customer, in a database of the virtual receptionist system. When a user asks a human agent a question, the question may be processed using natural language understanding to determine the intent and context of the question. A large language model (LLM) may be used to generate a suggested response by retrieving the most relevant information from a customer knowledge base. Retrieval-augmented generation (RAG) techniques may be used to enhance a suggested response with additional context. RAG techniques may be used to combine information retrieval with generative models to produce accurate and contextually relevant responses. In some embodiments, relevant documents or data may be retrieved from the customer knowledge base based on a user query. The retrieved information may be used to supplement the suggested response generated by the LLM, ensuring the suggested response is grounded in the specific data of the customer.

### V. System Messaging

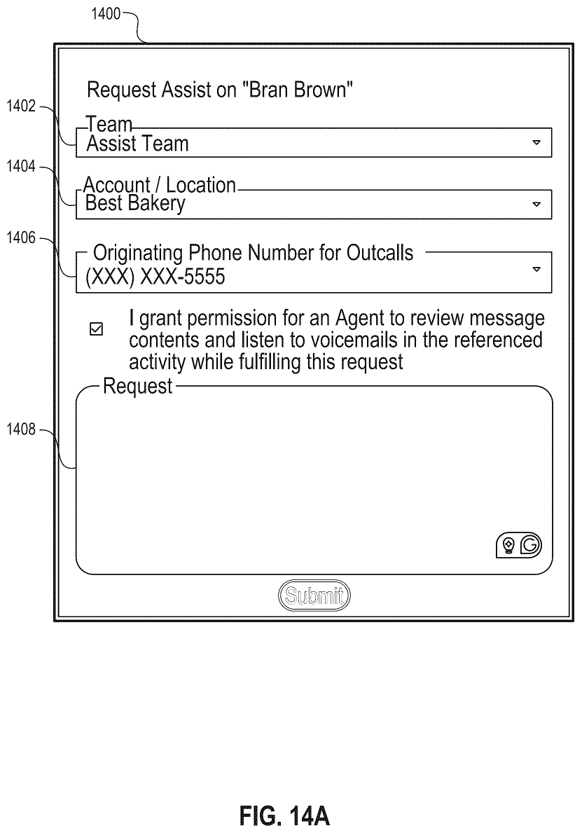

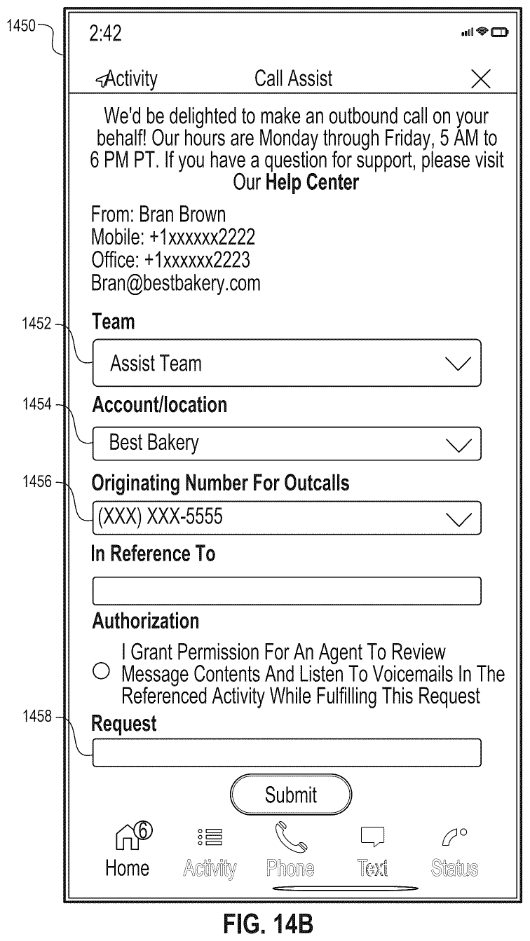

FIGS. 14A and 14B illustrate displays 1400 and 1450 of forms for enabling a customer to request that an agent of a virtual receptionist system conduct a communications session with a third party, on behalf of the customer, according to certain aspects of the present disclosure. For example, the communications session may include a telephone call or a text messaging session, and a third party may include a new client, existing client, or other contact of the customer. Display 1400 may include a panel or pop-up window of a desktop portal of the virtual receptionist system. Display 1450 may include a page of a mobile application of the virtual receptionist system. The forms may include Team fields 1402 and 1452, Account/Location fields 1404 and 1454, Originating Phone Number fields 1406 and 1456, and Request fields 1408 and 1458. When filling out one of the forms, the customer may select the team to which to direct the request (for example, Assist Team), the account the request regards (for example, Best Bakery), and which phone number of the account should be used as the originating identifier for the outbound communication (for example, XXX-XXX-5555, the main telephone number for Best Bakery). In some embodiments, Originating Phone Number fields 1406 and 1456 may populate with telephone number options including telephone numbers associated with the account selected in Account/Location fields 1404 and 1454.

From the desktop portal or the mobile application, a customer may submit an assist request, which may be routed to a queue of an agent of the team selected by the customer in a request form. For example, the request may ask an agent to reach out to a client of the customer to share or to gather information. When an agent accepts the assist request, an originating identifier field of a user interface of the agent may be populated with the originating identifier selected by the customer in the assist request form. In some embodiments, the originating identifier field may be noneditable by the agent. When the agent initiates the outbound communication, the originating identifier of the agent may be masked or replaced by the originating identifier selected by the customer. In some embodiments, an agent may include the customer in the interaction (for example, telephone call or text-based conversation) with a third party. A customer may receive a notification when the request has been fulfilled or when the request has been unfulfilled.

In some embodiments, messages, such as messages associated with a voicemail left by a client or with an assist request from a customer, may be propagated through a virtual receptionist platform in real time. In some embodiments, when a transaction is completed, a task may be created based on the transaction. By way of non-limiting examples, a transaction may include an interaction of an agent with a customer or a client, or a transaction may include an interaction of a customer with a mobile application or a desktop application of the virtual receptionist platform. By way of non-limiting examples, a task may include data logging, data storage, data aggregation, record updating, communications session recording, communications session transcribing, queue management, analytics, reporting, or notification dispatch.

In some embodiments, the virtual receptionist system may initially store the task in a local or temporary context, such as a session variable, a customer-specific or client-specific queue, or a transient memory store. Based on the task, a “copy-to-global” operation may be triggered, whereby a task, or data associated with a task (for example, voicemail content, customer ID, client ID, transaction timestamp), may be extracted from the local context. The task, or data associated with the task, may be stored in a global data structure (for example, a centralized database table, a global cache, a shared messaging queue) and may be tagged or indexed such that the task may be retrieved by other systems or components of the virtual receptionist system (for example, queuing systems, customer notification systems, or analytics or reporting systems), which may ensure data consistency, visibility, or reusability across the virtual receptionist platform and may enable coordination between systems.

In some embodiments, when a task is copied, an event may be triggered and published to an event bus or message queue. The event may include metadata, such as a task identifier, customer information, or a transaction timestamp. A notification service that monitors or subscribes to the event may detect the event and, based on the event or an associated task, may format a message and determine the appropriate recipient for the message. The message may be pushed to a customer portal or to an agent portal of the virtual receptionist platform. A message or a related notification may then be displayed in a dashboard of a user interface. In some embodiments, the message may be pushed while a customer is accessing the customer portal or while an agent is accessing the agent portal, enabling real-time delivery of the message. In some embodiments, an authorized user may be associated with multiple customer accounts. Using a customer portal, the authorized user may access the multiple customer accounts. A message associated with any customer account of the multiple customer accounts may be pushed to the customer portal of the authorized user.

### VI. Outbound Communication Identifier Masking

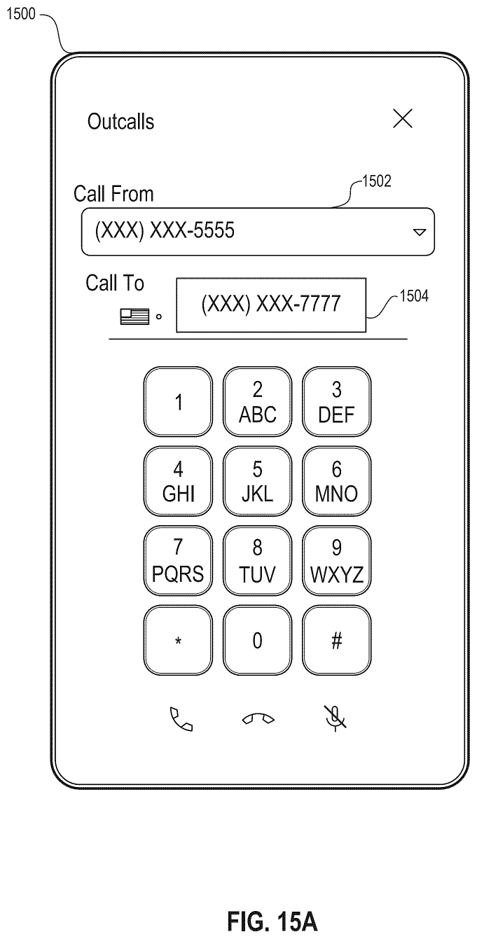

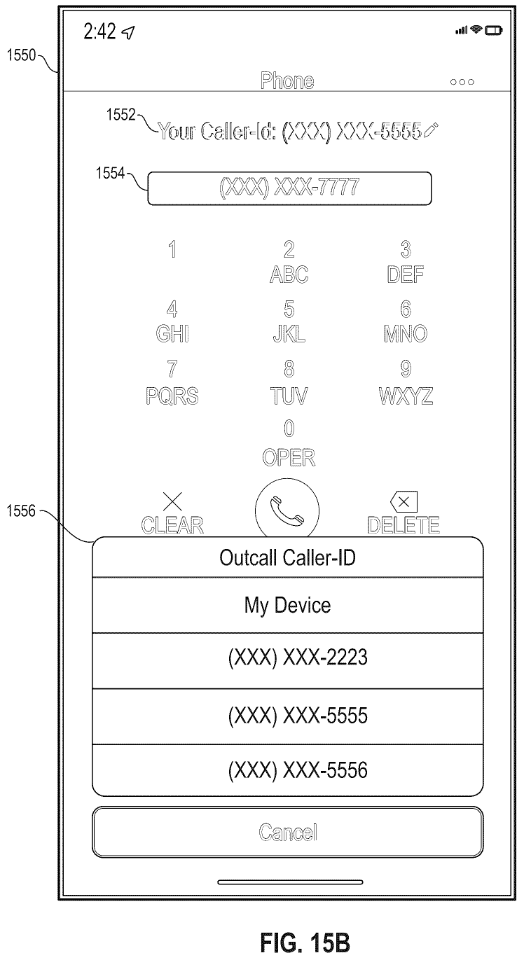

FIGS. 15A and 15B illustrate displays 1500 and 1550 of forms for enabling a customer to initiate an outbound communication using an identifier associated with an account of the customer, according to certain aspects of the present disclosure. For example, the outbound communication may include a telephone call or a text message, and a recipient of the outbound communication may include a new client, existing client, or other contact of the customer. Display 1500 may include a panel or a pop-up window of a desktop portal of a virtual receptionist system. Display 1550 may include a page of a mobile application of the virtual receptionist system. The forms may include Originating Phone Number fields 1502 and 1552, and Call To fields 1504 and 1554. When filling out one of the forms, the customer may input a recipient telephone number (for example, XXX-XXX-7777), and the customer may select an originating phone number for the outbound communication (for example, XXX-XXX-5555, the main telephone number for Best Bakery). The originating phone number may be associated with an account of the customer. In FIG. 15A, a drop-down menu may display a list of telephone number options. In FIG. 15B, pop-up window 1556 may display a list of telephone number options. From the desktop portal or the mobile application, a customer may place an outbound communication using the selected phone number as the originating identifier. An originating identifier of the desktop device or the mobile device of the customer may be masked or replaced by the originating identifier selected by the customer.

### VII. Reporting

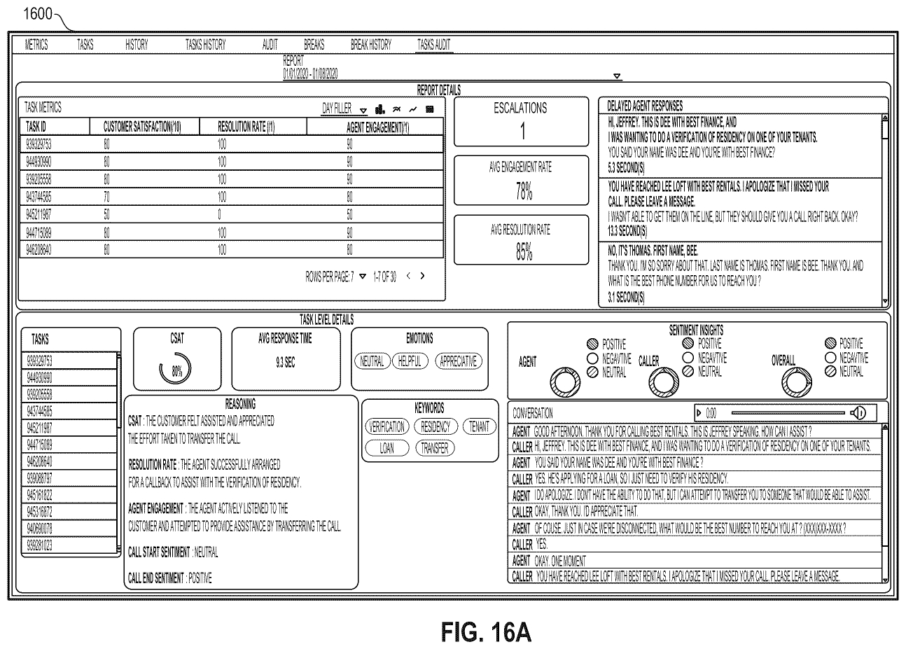

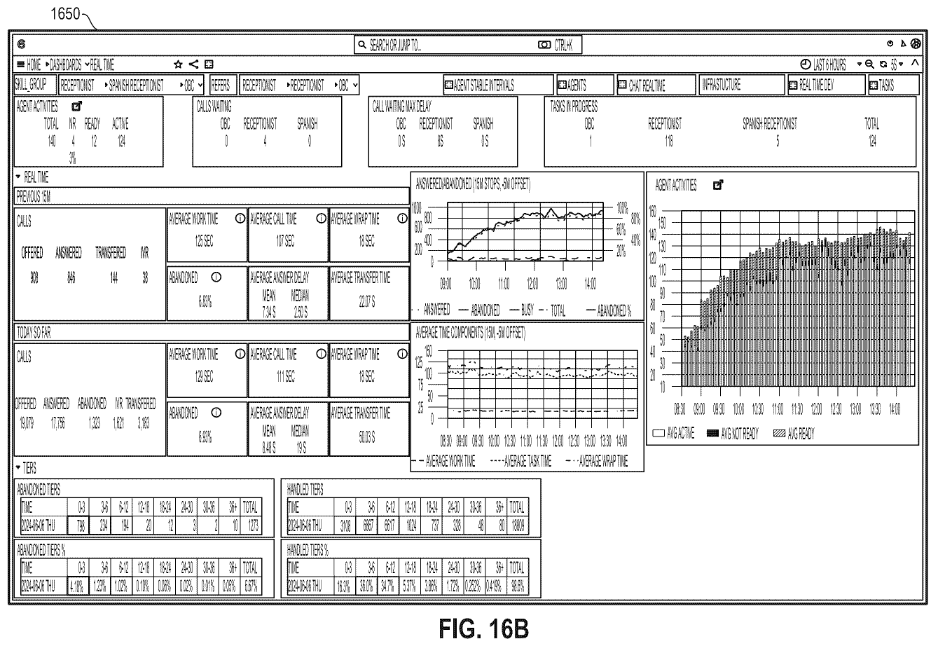

FIGS. 16A and 16B illustrate displays 1600 and 1650 of an example graphical user interface for generating communications session quality reports associated with a virtual receptionist platform, according to certain aspects of the present disclosure. Display 1600 may include a dashboard that may be configured to enable an agent (for example, a system administrator) to generate a call quality report. In some embodiments, a call quality report may be generated periodically, for example, every seven (7) days. Each report may analyze a selected or a random set of recorded communications sessions from a specified date range (for example, 1 Jan. 2020 to 8 Jan. 2020) and may provide key performance metrics such as customer satisfaction scores, resolution rates, agent engagement, or response times. For each communications session included in a report, an agent may view a task ID for the communications session, read the full transcript of the communications session, read or listen to a recording of the communications session, and review sentiment analysis of the communications session. A report may highlight keywords or emotional cues detected during a communications session, offering a comprehensive view of both the content and tone of the interaction.

Display 1650 may include a dashboard that may be configured to enable an agent (for example, a system administrator) to generate, in real time, a quality assurance report for the virtual receptionist system. Quality assurance widgets may include Agent Activities, Calls Waiting, Call Waiting Max Delay, Tasks in Progress, Average Work Time, Average Call Time, Average Wrap Time, Abandoned, Average Answer Delay, Average Transfer Time, Answered/Abandoned, Average Time Components, Agent Activities, Abandoned Tiers, Abandoned Tiers %, Handled Tiers, or Handled Tiers %.

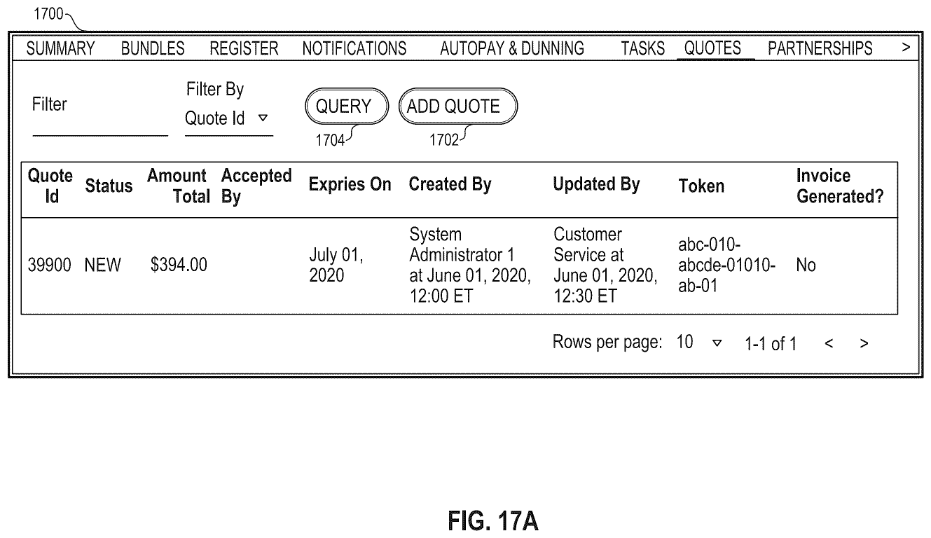

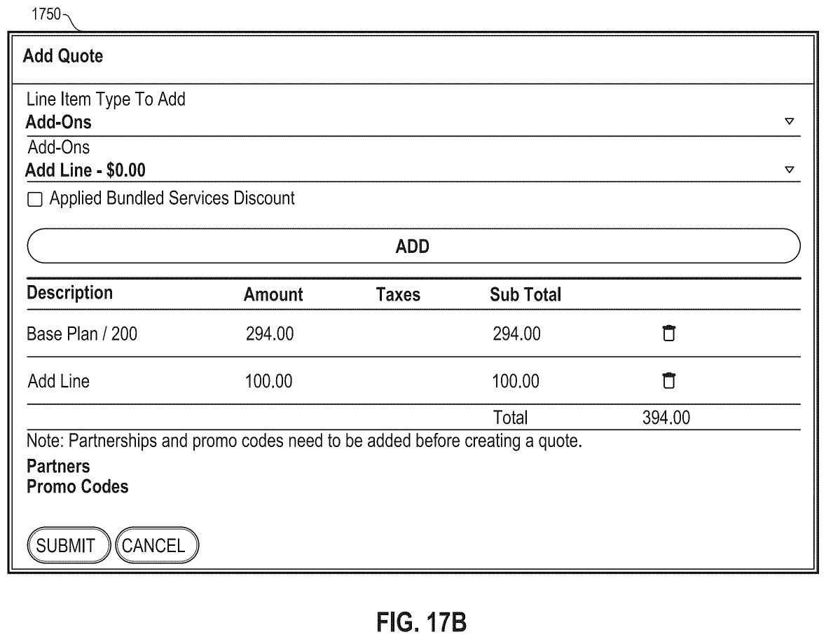

FIGS. 17A and 17B illustrate main display 1700 and pop-up display 1750 of an example graphical user interface for generating quotes for a customer of a virtual receptionist system, according to certain aspects of the present disclosure. FIG. 17A includes main display 1700, which may include interactive element 1702 and interactive element 1704. FIG. 17B includes pop-up display 1750. A user interaction (for example, clicking, hovering, swiping) with interactive element 1702 may open pop-up display 1750. A user interaction with interactive element 1704 may open a pop-up display enabling a user to search for an existing quote. An identifier (for example, a numerical identifier) may be assigned to a new quote by the virtual receptionist system. As shown in FIG. 17A, quote parameters may include status (for example, New), amount total (for example, USD 394.00), and expiration date. A user interaction (for example, clicking, hovering, swiping) with a row of an existing quote may open pop-up display 1750, enabling a user to edit the existing quote.

A quote may be generated based on a plan, an add-on, or a discount required for a customer. Once a quote has been generated, a custom hyperlink for the quote may be shared with the customer (for example, via email or text message). The hyperlink may open a webpage where the customer may view the details of the quote and choose to decline or accept it. If a customer chooses to accept the quote, the customer may accept the Terms and Privacy Policy and then make payment. Once a payment is made, the virtual receptionist system may automatically set up billing for the account. Whether a quote is accepted or declined, the virtual receptionist system may send an email notification to an agent of the virtual receptionist system with details regarding the quote and the account. A quote may expire after a predetermined period of time.

### VIII. Example System Processes

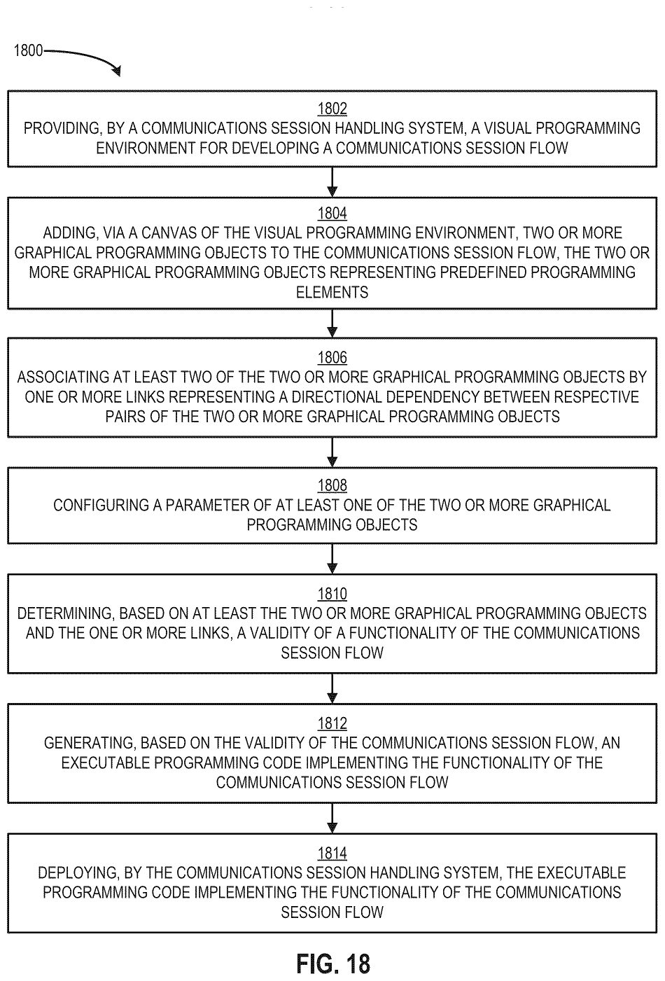

FIG. 18 illustrates an exemplary workflow for a process 1800 for generating executable programming code for a communications session flow, according to certain aspects of the present disclosure.

At operation 1802, process 1800 may include providing, by a communications session handling system, a visual programming environment for developing a communications session flow. The communications session flow may represent a telephonic communications session or a text messaging communications session.

At operation 1804, process 1800 may include adding, via a canvas of the visual programming environment, two or more graphical programming objects to the communications session flow. The two or more graphical programming objects may represent predefined programming elements. The visual programming environment may include a palette of a plurality of selectable graphical programming objects. The plurality of selectable graphical programming objects may include at least one of the two or more graphical programming objects. A first graphical programming object of the two or more graphical programming objects may represent routing logic triggered by the communications session handling system receiving an inbound communication associated with a customer profile stored by a database of the communications session handling system. The routing logic may define whether the inbound communication is directed to an automated system of the communications session handling system or to a human agent of the communications session handling system.

In some embodiments, adding the two or more graphical programming objects to the communications session flow may include receiving a selection of a communications session flow template or of at least one of the two or more graphical programming objects. In some embodiments, adding the two or more graphical programming objects to the communications session flow may further include populating, based on the selection, the canvas with at least one of the two or more graphical programming objects.

At operation 1806, process 1800 may include associating at least two of the two or more graphical programming objects by one or more links representing a directional dependency between respective pairs of the two or more graphical programming objects.

In some embodiments, associating at least two of the two or more graphical programming objects by the one or more links may include receiving a first selection of a first port of a first graphical programming object of the two or more graphical programming objects and a second selection of a second port of a second graphical programming object of the two or more graphical programming objects. In some embodiments, associating at least two of the two or more graphical programming objects by the one or more links may further include connecting, based on the first and the second selections, the first and second ports of the first and the second graphical programming objects by the one or more links.

At operation 1808, process 1800 may include configuring a parameter of at least one of the two or more graphical programming objects. In some embodiments, configuring the parameter of the at least one of the two or more graphical programming objects may include configuring the parameter according to a customer profile stored in a database of the communications session handling system.

In some embodiments, configuring the parameter of the at least one of the two or more graphical programming objects may include receiving a selection of the at least one of the two or more graphical programming objects. In some embodiments, configuring the parameter of the at least one of the two or more graphical programming objects may further include causing, based on the selection, display of a form with one or more fields. In some embodiments, configuring the parameter of the at least one of the two or more graphical programming objects may further include receiving, by a field associated with the parameter, a user input. In some embodiments, configuring the parameter of the at least one of the two or more graphical programming objects may further include configuring, based on the user input, the parameter of the at least one of the two or more graphical programming objects. In some embodiments, configuring the parameter of the at least one of the two or more graphical programming objects may further include modifying an appearance of the at least one of the two or more graphical programming objects to indicate the configuring of the parameter.

At operation 1810, process 1800 may include determining, based on at least the two or more graphical programming objects and the one or more links, a validity of a functionality of the communications session flow. In some embodiments, process 1800 may further include determining, based on at least the two or more graphical programming objects and the one or more links, an invalidity of the functionality of the communications session flow. In some embodiments, process 1800 may further include causing, by the visual programming environment, display of a notification of the invalidity of the functionality. The notification may include a color-coded pop-up window displaying a description of a source of the invalidity.

At operation 1812, process 1800 may include generating, based on the validity of the communications session flow, an executable programming code implementing the functionality of the communications session flow. In some embodiments, process 1800 may include generating, based on a modification of the communications session flow, one or more versions of the communications session flow. In some embodiments, process 1800 may further include storing, by a database of the communications session handling system, the one or more versions of the communications session flow. In some aspects of the embodiments, generating the executable programming code may include generating, based on the validity of a first version of the one or more versions of the communications session flow, the executable programming code implementing the functionality of the first version of the one or more versions of the communications session flow.

At operation 1814, process 1800 may include deploying, by the communications session handling system, the executable programming code implementing the functionality of the communications session flow.

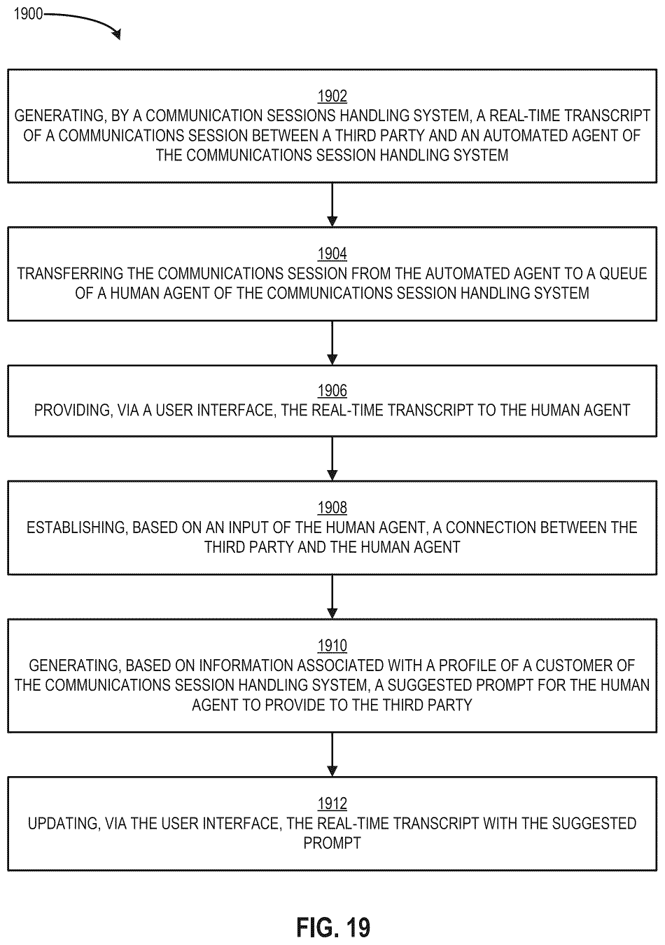

FIG. 19 illustrates an exemplary workflow for a process 1900 for assisting human agents of a communications session handling system during a communications session, according to certain aspects of the present disclosure.

At operation 1902, process 1900 may include generating, by a communications session handling system, a real-time transcript of a communications session between a third party and an automated agent of the communications session handling system. The communications session may include a telephonic communications session. The communications session may include a text messaging communications session. The third party may include a client of the customer of the communications session handling system.

At operation 1904, process 1900 may include transferring the communications session from the automated agent to a queue of a human agent of the communications session handling system. In some embodiments, transferring the communications session to the queue of the human agent includes transferring, based on a skill of the agent, the communications session to the queue of the human agent.

At operation 1906, process 1900 may include providing, via a user interface, the real-time transcript to the human agent.

At operation 1908, process 1900 may include establishing, based on an input of the human agent, a connection between the third party and the human agent.

At operation 1910, process 1900 may include generating, based on information associated with a profile of a customer of the communications session handling system, a suggested prompt for the human agent to provide to the third party. The profile of the customer may be stored by a database of the communications session handling system. In some embodiments, generating the suggested prompt for the human agent to provide to the third party may include providing at least a query of the third party and the profile of the customer to a large language model (LLM) configured to determine one or more suggested responses to the query. In some embodiments, generating the suggested prompt for the human agent to provide to the third party may further include generating, by the LLM, the suggested prompt for the human agent to provide to the third party.

At operation 1912, process 1900 may include updating, via the user interface, the real-time transcript with the suggested prompt. In some embodiments, updating the real-time transcript may include updating the real-time transcript with at least one of a query of the third party and an actual prompt of the human agent.

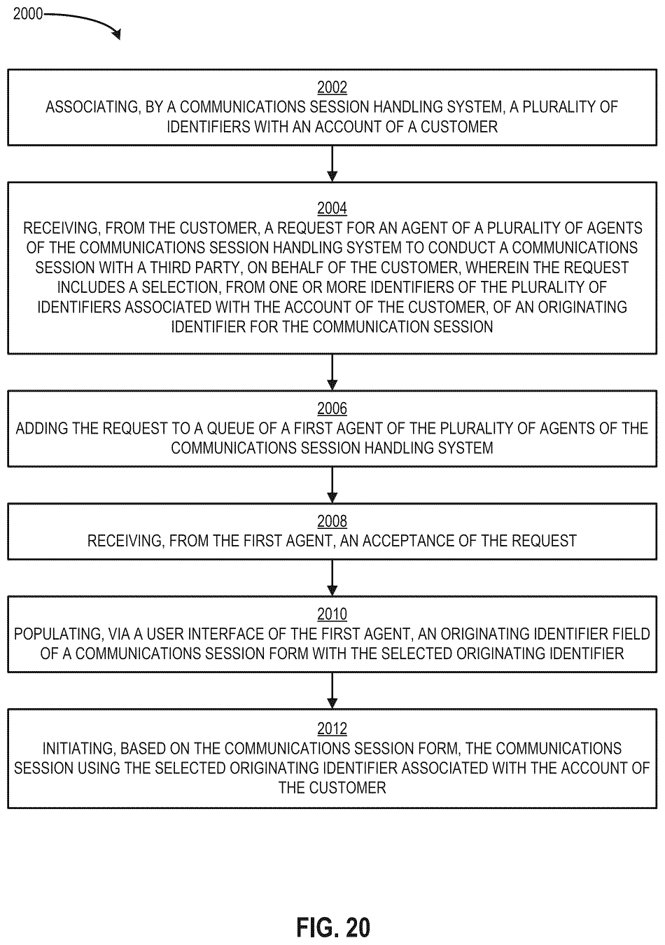

FIG. 20 illustrates an exemplary workflow for a process 2000 for masking an originating identifier of an agent of a communications session handling system, according to certain aspects of the present disclosure.

At operation 2002, process 2000 may include associating, by a communications session handling system, a plurality of identifiers with an account of a customer.

At operation 2004, process 2000 may include receiving, from the customer, a request for an agent of a plurality of agents of the communications session handling system to conduct a communications session with a third party, on behalf of the customer. The communications session may include a text messaging communications session. The communications session may include a telephonic communications session. The request may include a selection, from one or more identifiers of the plurality of identifiers associated with the account of the customer, of an originating identifier for the communications session. The originating identifier may include a telephone number.

At operation 2006, process 2000 may include adding the request to a queue of a first agent of the plurality of agents of the communications session handling system. The first agent may include a human agent. The first agent may include an automated agent. In some embodiments, adding the request to the queue of the first agent may include adding, based on a skill of the first agent, the request to the queue of the first agent.

At operation 2008, process 2000 may include receiving, from the first agent, an acceptance of the request.

At operation 2010, process 2000 may include populating, via a user interface of the first agent, an originating identifier field of a communications session form with the selected originating identifier. The originating identifier field may be noneditable by the first agent.

At operation 2012, process 2000 may include initiating, based on the communications session form, the communications session using the selected originating identifier associated with the account of the customer.

The techniques described herein may be implemented as method(s) (for example, process 1800, 1900, and 2000) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIGS. 18-20 may be performed by a processor circuit executing instructions stored in a memory circuit, in a client device, a remote server, or a database, communicatively coupled through a network (for example, processors 212, memories 220, client device(s) 110, server(s) 130, database(s) 152, and network 150). In some embodiments, one or more of the steps in processes 1800, 1900, and 2000 may be performed by one or more of modules 308, 310, 312, 314, 316, 318, and/or 320 (as described in FIG. 3).

Although FIGS. 18-20 show example blocks of process 1800, process 1900, and process 2000, respectively, in some implementations, process 1800, process 1900, and process 2000 may include additional blocks, fewer blocks, different blocks, or differently arranged blocks than those depicted in FIGS. 18-20. For explanatory purposes, the steps of process 1800, process 1900, and process 2000 are described herein as occurring in serial, or linearly. However, multiple instances of process 1800, process 1900, and process 2000 may occur in parallel, in a different order, simultaneously, quasi-simultaneously or overlapping in time.

### Hardware Overview

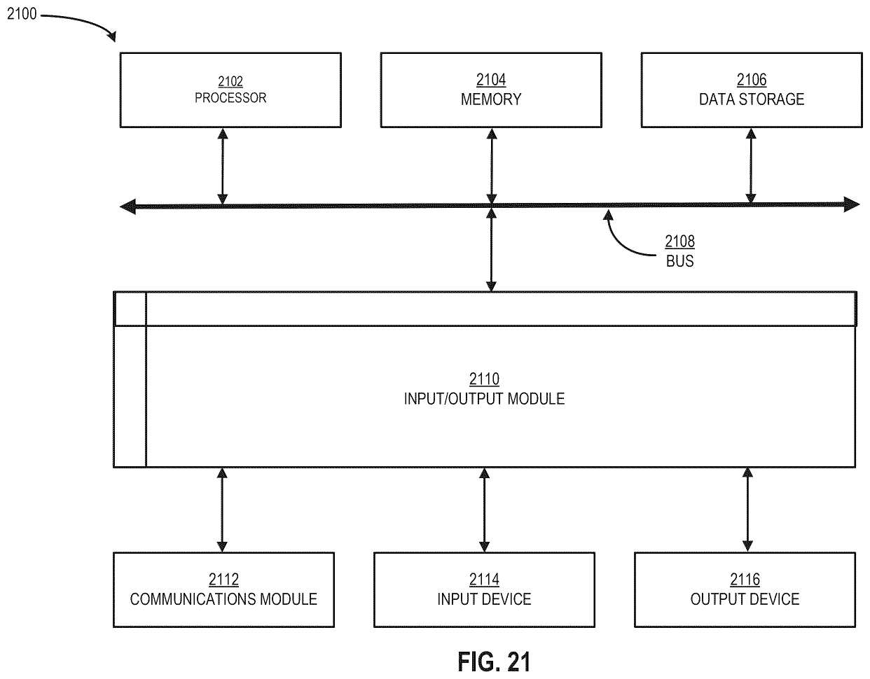

FIG. 21 is a block diagram illustrating an exemplary computer system 2100 with which aspects of the subject technology may be implemented. In certain aspects, computer system 2100 may be implemented using hardware or a combination of software and hardware, either in a dedicated server, or integrated into another entity, or distributed across multiple entities. Computer system 2100 may include a desktop computer, a laptop computer, a tablet, a phablet, a smartphone, a feature phone, a server computer, or otherwise. A server computer may be located remotely in a data center or be stored locally.

Computer system 2100 may include a bus 2108 or other communication mechanism for communicating information, and a processor 2102 (for example, processors 212) coupled with bus 2108 for processing information. By way of example, computer system 2100 may be implemented with one or more processors 2102. Processor 2102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 2100 may include, in addition to hardware, code that creates an execution environment for the computer program in question, for example, code that constitutes processor firmware, a protocol stack, a database management system, an operating system, or a combination of one or more of them stored in an included memory 2104 (for example, memories 220), such as a Random Access Memory (RAM), a Flash Memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 2108 for storing information and instructions to be executed by processor 2102. Processor 2102 and memory 2104 may be supplemented by, or incorporated in, special purpose logic circuitry.

The instructions may be stored in memory 2104 and implemented in one or more computer program products, for example, one or more modules of computer program instructions encoded on a computer-readable medium for execution by, or to control the operation of, computer system 2100, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 2104 may also be used for storing temporary variable or other intermediate information during execution of instructions to be executed by processor 2102.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program may be deployed to be executed on one computer or on multiple computers that are located at one site or distributed across multiple sites and interconnected by a communication network. The processes and logic flows described in this specification may be performed by one or more programmable processors executing one or more computer programs to perform functions by operating on input data and generating output.

Computer system 2100 may further include a data storage device 2106 such as a magnetic disk or optical disk, coupled to bus 2108 for storing information and instructions. Computer system 2100 may be coupled via input/output module 2110 to various devices. Input/output module 2110 may be any input/output module. Exemplary input/output modules 2110 may include data ports such as USB ports. Input/output module 2110 may be configured to connect to communications module 2112. Exemplary communications modules 2112 (for example, communications modules 218) may include networking interface cards, such as Ethernet cards and modems. In certain aspects, input/output module 2110 may be configured to connect to a plurality of devices, such as an input device 2114 and/or an output device 2116. Exemplary input devices 2114 may include a keyboard and a pointing device, for example, a mouse or a trackball, by which a user may provide input to the computer system 2100. Other kinds of input devices 2114 may be used to provide for interaction with a user as well, such as a tactile input device, visual input device, audio input device, or brain-computer interface device. For example, feedback provided to the user may be any form of sensory feedback, for example, visual feedback, auditory feedback, or tactile feedback; and input from the user may be received in any form, including acoustic, speech, tactile, or brain wave input. Exemplary output devices 2116 may include display devices, such as an LCD (liquid crystal display) monitor, for displaying information to the user.

According to one aspect of the present disclosure, the client device and the server may be implemented using computer system 2100 in response to processor 2102 executing one or more sequences of one or more instructions contained in memory 2104. Such instructions may be read into memory 2104 from another machine-readable medium, such as data storage device 2106. Execution of the sequences of instructions contained in main memory 2104 may cause processor 2102 to perform the process steps described herein. One or more processors in a multi-processing arrangement may also be employed to execute the sequences of instructions contained in memory 2104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, for example, a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system may be interconnected by any form or medium of digital data communication, for example, a communication network. The communication network (for example, network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 2100 may include clients and servers. A client and server may be generally remote from each other and typically interact through a communication network. The relationship of client and server arises by virtue of computer programs running on the respective computers and having a client-server relationship to each other. Computer system 2100 may be, for example, and without limitation, a desktop computer, laptop computer, or tablet computer. Computer system 2100 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein may refer to any medium or media that participates in providing instructions to processor 2102 for execution. Such a medium may take many forms, including, but not limited to, non-volatile media, volatile media, and transmission media. Non-volatile media may include, for example, optical or magnetic disks, such as data storage device 2106. Volatile media may include dynamic memory, such as memory 2104. Transmission media may include coaxial cables, copper wire, and fiber optics, including the wires forming bus 2108. Common forms of machine-readable media may include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 13, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in any claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method claims or clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

It should be understood that the original applicant herein determines which technologies to use and/or productize based on their usefulness and relevance in a constantly evolving field, and what is best for the original applicant and its users. Accordingly, it may be the case that the systems and methods described herein have not yet been and/or will not later be used and/or productized by the original applicant. It should also be understood that implementation and use, if any, by the original applicant, of the systems and methods described herein are performed in accordance with the privacy policies of the original applicant. These policies are intended to respect and prioritize user privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the privacy settings or preferences of the user. It should also be understood that the original applicant intends that the systems and methods described herein, if implemented or used by other entities, be in compliance with privacy policies and practices that are consistent with the objective of the original applicant to respect user privacy.

What is claimed is:

1. A computer-implemented method for generating executable programming code for a communications session flow, comprising:
providing, by a communications session handling system, a visual programming environment for developing a communications session flow;
adding, via a canvas of the visual programming environment, two or more graphical programming objects to the communications session flow, the two or more graphical programming objects representing predefined programming elements;
associating at least two of the two or more graphical programming objects by one or more links representing a directional dependency between respective pairs of the two or more graphical programming objects;
configuring a parameter of at least one of the two or more graphical programming objects;
determining, based on at least the two or more graphical programming objects and the one or more links, a validity of a functionality of the communications session flow; and
generating, based on the validity of the communications session flow, an executable programming code implementing the functionality of the communications session flow.

2. The computer-implemented method of claim 1, wherein the communications session flow represents a telephonic communications session or a text messaging communications session.

3. The computer-implemented method of claim 1, wherein:
the visual programming environment includes a palette of a plurality of selectable graphical programming objects; and
the plurality of selectable graphical programming objects includes at least one of the two or more graphical programming objects.

4. The computer-implemented method of claim 1, wherein:
a first graphical programming object of the two or more graphical programming objects represents routing logic triggered by the communications session handling system receiving an inbound communication associated with a customer profile stored by a database of the communications session handling system; and
the routing logic defines whether the inbound communication is directed to an automated system of the communications session handling system or to a human agent of the communications session handling system.

5. The computer-implemented method of claim 1, wherein adding the two or more graphical programming objects to the communications session flow includes:
receiving a selection of a communications session flow template or of at least one of the two or more graphical programming objects; and
populating, based on the selection, the canvas with at least one of the two or more graphical programming objects.

6. The computer-implemented method of claim 1, wherein associating at least two of the two or more graphical programming objects by the one or more links includes:
receiving a first selection of a first port of a first graphical programming object of the two or more graphical programming objects and a second selection of a second port of a second graphical programming object of the two or more graphical programming objects; and
connecting, based on the first and the second selections, the first and second ports of the first and the second graphical programming objects by the one or more links.

7. The computer-implemented method of claim 1, wherein configuring the parameter of the at least one of the two or more graphical programming objects includes configuring the parameter according to a customer profile stored in a database of the communications session handling system.

8. The computer-implemented method of claim 1, wherein configuring the parameter of the at least one of the two or more graphical programming objects includes:
receiving a selection of the at least one of the two or more graphical programming objects;
causing, based on the selection, display of a form with one or more fields;
receiving, by a field associated with the parameter, a user input;
configuring, based on the user input, the parameter of the at least one of the two or more graphical programming objects; and
modifying an appearance of the at least one of the two or more graphical programming objects to indicate the configuring of the parameter.

9. The computer-implemented method of claim 1, further comprising:
generating, based on a modification of the communications session flow, one or more versions of the communications session flow; and
storing, by a database of the communications session handling system, the one or more versions of the communications session flow.

10. The computer-implemented method of claim 9, wherein generating the executable programming code includes generating, based on the validity of a first version of the one or more versions of the communications session flow, the executable programming code implementing the functionality of the first version of the one or more versions of the communications session flow.

11. The computer-implemented method of claim 1, further comprising:
determining, based on at least the two or more graphical programming objects and the one or more links, an invalidity of the functionality of the communications session flow; and
causing, by the visual programming environment, display of a notification of the invalidity of the functionality, the notification including a color-coded pop-up window displaying a description of a source of the invalidity.

12. The computer-implemented method of claim 1, further comprising:
deploying, by the communications session handling system, the executable programming code implementing the functionality of the communications session flow.

13. A system, comprising:
one or more processors; and
one or more memories coupled to at least one of the one or more processors, wherein the one or more memories comprise computer-readable program instructions, which when executed by at least one of the one or more processors, cause the system to:
provide, by a communications session handling system, a visual programming environment for developing a communications session flow;
add, via a canvas of the visual programming environment, two or more graphical programming objects to the communications session flow, the two or more graphical programming objects representing predefined programming elements;
associate at least two of the two or more graphical programming objects by one or more links representing a directional dependency between respective pairs of the two or more graphical programming objects;
configure a parameter of at least one of the two or more graphical programming objects;
determine, based on at least the two or more graphical programming objects and the one or more links, a validity of a functionality of the communications session flow; and
generate, based on the validity of the communications session flow, an executable programming code implementing the functionality of the communications session flow.

14. The system of claim 13, wherein:
the communications session flow represents a telephonic communications session or a text messaging communications session;
the visual programming environment includes a palette of a plurality of selectable graphical programming objects; and
the plurality of selectable graphical programming objects includes at least one of the two or more graphical programming objects.

15. The system of claim 13, wherein:
a first graphical programming object of the two or more graphical programming objects represents routing logic triggered by the communications session handling system receiving an inbound communication associated with a customer profile stored by a database of the communications session handling system; and
the routing logic defines whether the inbound communication is directed to an automated system of the communications session handling system or to a human agent of the communications session handling system.

16. The system of claim 13, wherein to add the two or more graphical programming objects to the communications session flow includes to:
receive a selection of a communications session flow template or of at least one of the two or more graphical programming objects; and
populate, based on the selection, the canvas with at least one of the two or more graphical programming objects.

17. The system of claim 13, wherein to associate at least two of the two or more graphical programming objects by the one or more links includes to:
receive a first selection of a first port of a first graphical programming object of the two or more graphical programming objects and a second selection of a second port of a second graphical programming object of the two or more graphical programming objects; and
connect, based on the first and the second selections, the first and second ports of the first and the second graphical programming objects by the one or more links.

18. The system of claim 13, wherein to configure the parameter of the at least one of the two or more graphical programming objects includes to configure the parameter according to a customer profile stored in a database of the communications session handling system.

19. The system of claim 13, wherein to configure the parameter of the at least one of the two or more graphical programming objects includes to:
receive a selection of the at least one of the two or more graphical programming objects;
cause, based on the selection, display of a form with one or more fields;
receive, by a field associated with the parameter, a user input;
configure, based on the user input, the parameter of the at least one of the two or more graphical programming objects; and
modify an appearance of the at least one of the two or more graphical programming objects to indicate the configuring of the parameter.

20. A non-transitory computer-readable storage medium including computer-readable instructions embodied therein, which when executed by one or more processors, cause a computer system to:
provide, by a communications session handling system, a visual programming environment for developing a communications session flow;
add, via a canvas of the visual programming environment, two or more graphical programming objects to the communications session flow, the two or more graphical programming objects representing predefined programming elements;
associate at least two of the two or more graphical programming objects by one or more links representing a directional dependency between respective pairs of the two or more graphical programming objects;
configure a parameter of at least one of the two or more graphical programming objects;
determine, based on at least the two or more graphical programming objects and the one or more links, a validity of a functionality of the communications session flow; and
generate, based on the validity of the communications session flow, an executable programming code implementing the functionality of the communications session flow.
